(19) United States
(12) Patent Application Publication
(10) Pub. No.: US 2015/0162840 A1
(43) Pub. Date: Jun. 11, 2015

(54) DC-DC CONVERTER CIRCUIT USING AN LLC CIRCUIT IN THE REGION OF VOLTAGE GAIN ABOVE UNITY

(71) Applicant: ARDA POWER INC, Oakville (CA)

(72) Inventors: Damien Francis Frost, Toronto (CA); Luis Eduardo Zubieta, Oakville (CA); Peter Waldemar Lehn, Toronto (CA)

(21) Appl. No.: 14/399,563

(22) PCT Filed: Nov. 6, 2012
(86) PCT No.: PCT/CA2012/001021

§ 371 Date: Nov. 7, 2014

Related U.S. Application Data
(63) Continuation-in-part of application No. 13/469,060, filed on May 10, 2012.
Application No. 13/469,060 is a continuation-in-part of application No. 13/384,294, filed on Apr. 2, 2012.
(60) Provisional application No. 61/305,590, filed on Feb. 18, 2010.

(51) Int. Cl. H02M 3/335

(52) U.S. Cl. CPC H02M 3/33507

(57) ABSTRACT

A method of operating a resonant DC-DC converter is provided where the resonant DC-DC converter includes a high voltage boost LLC circuit. The method includes providing variable power flow control to the LLC circuit with externally determined input and output voltages using frequency control. Frequency control is applied such that it emulates different loading conditions. For fixed input and output voltages this corresponds to operating along horizontal curves on the voltage gain compared to the switching frequency operating plane. A DC-DC converter is also provided including (A) a low voltage full-bridge or half-bridge DC-AC converter; (B) an LLC resonant tank; (C) a high voltage AC-DC converter or rectifier; and (D) a high voltage controllable switch; wherein the high voltage controllable switch is controllable to regulate power flow from an input to an output of the DC-DC converter based on an externally determined voltage gain ratio, wherein the LLC resonant lank operates with a minimum boosting having an effective value above unity over the entire operating range. A method of designing a resonant DC-DC converter for high voltage boost ratio is also provided.

### PRIORITY CLAIM

This application claims priority to U.S. patent application Ser. No. 13/469,060 filed on May 10, 2012, which is hereby incorporated by reference in its entirety (the “Base Patent”).

### FIELD OF THE INVENTION

This present invention relates generally to a power converting apparatus, and more specifically to a DC-DC converter using an LLC circuit in the region of voltage gain above unity.

### BACKGROUND TO THE INVENTION

Direct current (DC) architectures are well known, for example for the transmission and distribution of power. DC architectures generally provide efficient (low loss) distribution of electrical power relative to alternating current (AC) architectures.

The importance of DC architectures has increased because of factors including: (1) the reliance of computing and telecommunication equipment on DC input power, (2) the reliance of variable speed AC and DC drives on DC input power, (3) the production of DC power by solar photovoltaic systems, fuel cells, and various wind turbine technologies; (4) propulsion systems in electric and hybrid vehicles, marine applications; (5) aerospace applications; (6) micro-grids and smart grids, including the above, energy storage and electric charging stations; and (7) other systems that require converters with varying input voltage and load.

The widespread use of DC architectures has also expanded the need for DC-DC power converter circuits. Moreover, there is a further need for DC-DC power converter circuits that are efficient and low cost.

Traditionally, cost reduction is achieved in part by (1) reducing the components of DC-DC power converters, and (2) increasing the switching frequency of DC-DC power converters. These cost reduction methods can be achieved by implementing transformerless DC-DC converters that switch at high frequency. High frequency operation allows the circuit designer to reduce the size, and therefore the crust, of expensive components such as transformers, inductors and capacitors. Two of the most common transformerless DC-DC converters are the buck converter 10, as shown in FIG. 1, for stopping down the voltage, and the boost converter 12, as shown in FIG. 2, for stepping up the voltage.

While both of these circuits are capable of achieving very high conversion efficiency when the input-to-output voltage ratio is near unity and the switching frequency is relatively low, their efficiency Is less than optimal when the voltage ratio becomes high or the switching frequency is increased to reduce the total size of the converter. In addition, in their basic form they do not provide galvanic isolation. Loss of efficiency, along with other operational problem, are caused by circuit parasitics, including such circuit effects as diode forward voltage drop, switch and diode conduction losses, switching losses, switch capacitances, inductor winding capacitance, and lead and trace inductances. Furthermore, it is known in the prior art that boost converters in particular are susceptible to parasitic effects and high efficiency operation requires low step up ration, e.g. 1:2 or 1:3.

B. Buti, P. Bartal, I. Nagy, “Resonant boost converter operating above its resonant frequency,” EPE, Dresden, 2005, is an example of a resonant DC-DC power converter, where a resonant tank is excited at its resonant frequency to achieve high step-up/step-down conversion ratios without the use of transformers. An H-bridge based resonant DC-DC power converter was proposed by D. Jovcic (D. Jovcic, “Step-up MW DC-DC converter for MW size applications,” Institute of Engineering Technology, paper IET-2009-407) and modified for enhanced modularity by A. Abbas and P. Lehn (A. Abbas, P. Lehn, “Power electronic circuits for high voltage DC to DC converters,” University of Toronto, Invention disclosure RIS#10001913, 2009-03-31).

The converter disclosed in B. Buti, P. Bartal, I. Nagy, “Resonant boost converter operating above its resonant frequency” EPE, Dresden, 2005, requires two perfectly, or near to perfectly, matched inductors, each only utilized half of the time, to function properly. Perfect matching is not viable in many applications. Moreover, the fact that the inductor is only utilized half of the time effectively doubles the inductive requirements of the circuit. This is undesirable as the inductor is typically the single most expensive component in the power circuit. Furthermore, the converter in B. Buti, P. Bartal, I. Nagy, “Resonant boost converter operating above its resonant frequency,” EPE, Dresden, 2005, requires both a positive and negative input supply. This is often not available.

The converters disclosed in D. Jovcic. “Step-up MW DC-DC converter for MW size applications,” Institute of Engineering Technology, paper IET-2009-407, and A. Abbas, P. Lehn, “Power electronic circuits for high voltage DC to DC converters,” University of Toronto Invention disclosure RIS#10001913, 2009-03-31, uses four high voltage reverse blocking switching devices. For medium frequency applications (approx. 20 kHz-100 kHz) such devices are not readily available thus they need to be created out of a series combination of an insulated-gate bipolar transistor (“IGBT”) and a diode, or a metal oxide semiconductor field effect transistor (“MOSFET”) MOSFET and a diode. This not only further increases system cost but it also nearly doubles the device conduction losses of the converter.

Galvanic isolation and larger voltage boost and buck ratios are possible with resonant and quasi-resonant DC-DC converters. These converters use inductive and capacitive components to shape the currents and/or voltages so that the switching losses are reduced allowing higher switching frequencies without a large efficiency penalty as explained in N. Mohan, T. Undeland, W. Robbins, “Power electronics; converters, applications, and design,” Wiley, 1995. Resonant and quasi-resonant DC-DC converters can be implemented with or without galvanic isolation.

A resonant converter with galvanic isolation is found in Bor-Ren and Shin-Feng Wu, “ZVS Resonant Converter With Series-Connected Transformers,” Industrial Electronics, IEEE Transactions on, vol. 58, No. 8, pp. 3547-3554, August 2011. In this work, a series resonant converter is implemented with multiple transformers connected in series. The proposed converter is designed to be used as a power factor pre-regulator in consumer electronic applications. The converter operates near the characteristic frequency defined by the resonant capacitor and resonant inductor. ZVS is achieved for all of the input switching component.

This converter analyzed by Bor-Ren Lin and Shin-Fang Wu uses a conventional resonant converter design approach. The resonant tank is only able to provide minimal voltage boosting, if necessary, and any voltage boosting or bucking must come entirely from the transformer turns ratio. The small amount of voltage boosting that can be provided is used when the input voltage is low. Furthermore, due to the resonant tank design, this converter would not be suitable to control of the power flow between an input and an output voltage source.

Series resonant converters and parallel resonant converters are known to be very efficient for a small range of operating points. They can be implemented without galvanic isolation or with galvanic isolation. For applications that require a large range of input voltages and loads, they are not ideal. As shown in B. Yang, “Topology Investigation for Front End DC/DC Power Conversion for Distributed Power System”, Ph.D. Dissertation, Virginia Tech, 2003, both series resonant converters and parallel resonant converters suffer from large circulating currents, and large switching cents when the input voltage is high.

In B. Yang. “Topology Investigation for Front Bad DC/DC Power Conversion for Distributed Power System”, Ph.D. Dissertation, Virginia Tech, 2003 the author shows that some of the limitations in traditional series resonant or parallel resonant converters can be overcome by using an LLC resonant converter.

R. L. Lin and C. W. Lin, “Design criteria for resonant tank or LLC DC to DC resonant converter”. IEEE 2010, presents a conventional design approach to obtain an LLC step down converter. The designed converter has a maximum voltage gain from the resonant tank of only 1.44, which is needed when the input voltage is at a minimum. For high input voltage the circuit is operated at, or just below, unity gain. A 9:1 transformer provides the net voltage step down needed for the application.

IL Hu. X. Pang, Q. Zhang, Z. Shen, and I. Batarseh, “Optimal design considerations for a modified LLC converter with wide input voltage range capability suitable for PV applications,” ECCE 2011, is an example of a conventional LLC design methodology applied to a step up converter where the resonant circuit provides close to unity gain. All of the voltage gain is achieved through the output transformer.

In both of the works of R. L. Lin et. al. and H. He et. al., the conventional LLC design methodology used yields a resonant tank with very low voltage boosting properties. Furthermore, both designs require a resistive load at the output for proper functionality. These converters, and all LLC converters designed with the conventional method, are not suitable for applications where the power flow between two voltage sources is regulated.

In U.S. Pat. No. 6,344,979 an LLC converter is claimed where the converter is operated between the two characteristic frequencies of the converter,

$$ω = \sqrt{{L}_{r} {C}_{r}} and ω = \sqrt{( {L}_{m} + {L}_{r} ) {C}_{r}} ,$$

to maintain output voltage regulation. However, the authors failed to address the high voltage gain region of operation and the advantages of operating there, as well as bow, by choosing the right components, the designer can always ensure operation in this region. In addition, the zero current switching region of operation, designated as “LHS Operation” in this document, was not utilized nor were the benefits of operating in this region identified. The “LHS Operation” region is also only usable by a careful selection of resonant tank components, as identified in the current invention.

### SUMMARY OF INVENTION

In one aspect of the invention, a method of operating a resonant DC-DC converter is provided, the resonant DC-DC converter comprising a high voltage boost LLC circuit, wherein the method comprises providing variable power flow control to the LLC circuit with externally determined input and output voltages using frequency control.

In a further aspect of the invention, the externally determined output voltage is created by either a single externally determined output voltage, or a series connection of two externally determined output voltages to create a bi-polar output.

In another aspect of the invention, a method is provided wherein frequency control is applied such that it emulates different loading conditions thus operating along horizontal curves on the voltage gain compared to the switching frequency operating plane.

In a still other aspect of the invention, the LLC circuit includes an LLC resonant tank, and wherein the LLC resonant tank operates with a minimum booting having an effective value that is above unity over the entire operating range.

In another aspect, of the method of the invention, the minimum boosting results in controllable transfer of power via change of switching frequency.

In another aspect of the invention, the method further comprises maintaining an externally determined voltage gain and using frequency control to enable movement between the load curves, and to control this movement within a frequency control region where there is horizontal separation amongst the load curves.

In another aspect of the invention, the method further comprises: (A) operating the high voltage boost LLC circuit in a region close to a resonant frequency determined by a resonant inductor, magnetizing inductor and a resonant capacitor, to achieve a high voltage boost and (B) utilizing unipolar or bipolar resonant rank excitation to improve converter efficiency in the high voltage boost circuit.

In yet another aspect of the invention, a balanced bipolar DC output is provided wherein the output capacitor voltages are automatically balanced.

In a sill other aspect of the invention, the DC-DC converter further includes a resonant inductor, a magnetizing inductor and a resonant capacitor, and the method comprises the further step of selecting these components such that the yield over the entire range of operation is an effective voltage gain that is greater than unity.

In another aspect of the invention, the LLC converter is implemented with a transformer to allow decoupling of the resonant circuit pin from the externally determined voltage gain.

In a still other aspect of the invention, the effective voltage gain value and the components am selected so as to minimize the effective voltage gain of the resonant circuit, while being greater than unity, and provide controllability of the DC-DC converter via frequency.

In another aspect of the invention, the method further comprises operating at a range of input stage switching frequencies in an LLC circuit whereby a change in input voltage results in a change in load or transferred power, such that a decoupling between the input voltage and load is not required.

In one aspect of the invention, a resonant DC-DC converter is provided for high voltage step-up ratio, where the resonant DC-DC converter for high voltage step-up ratio comprises: (A) a low voltage full-bridge or half-bridge DC-AC converter (B) an LLC resonant tank; (C) a high voltage AC-DC converter or rectifier and (D) a high voltage controllable switch; wherein the high voltage controllable switch is controllable to regulate power flow from an input to an output of the DC-DC converter based on an externally determined voltage gain ratio, wherein the LLC resonant tank operates with a minimum boosting having an effective value above unity over the entire operating range.

In another aspect of the invention, the DC-DC converter is designed to provide variable power flow control using frequency control.

In another aspect of the invention, a DC-DC converter is provided wherein application of frequency control emulates different loading conditions thus enabling operation along horizontal curves on a voltage gain compared to a switching frequency operating plane.

In another aspect of the invention, a DC-DC converter is provided wherein the minimum boosting results in controllable transfer of power based on change of switching frequency.

In yet another aspect of the invention, a DC-DC converter is provided that maintains an externally determined voltage gain, and uses frequency control to enable movement between the load curves, and controls this movement within a frequency control region where there is horizontal separation amongst the load curves.

In another aspect of the invention, a DC-DC converter is provided that is designed for: (A) operation of a high voltage boost LLC circuit in a region close to a resonant frequency determined by a resonant inductor, magnetizing inductor and a resonant capacitor, to achieve a high voltage boost; and (B) use of unipolar or bipolar resonant tank excitation to improve converter efficiency in the high voltage boost circuit.

In another aspect of the present invention, a DC-DC converter is provided that further comprises a balanced bipolar DC output wherein output capacitor voltages are automatically balanced.

In a still other aspect, a DC-DC converter is provided that further includes a resonant inductor, a magnetizing inductor and a resonant capacitor, these components being selected such that the yield over the entire range of operation is an effective voltage gain that is greater than unity.

In yet another aspect of the invention, a DC-DC converter is provided that comprises a transformer to allow decoupling of the resonant circuit gain from the externally determined voltage gain.

In a still other aspect of the invention, a DC-DC converter if provided wherein the components are selected so as to minimize the effective voltage gain of the resonant circuit, while being greater than unity, and provide controllability of the DC-DC converter via frequency.

In one aspect of the invention, a method of designing a resonant DC-DC converter for high voltage boost ratio is provided, the DC-DC converter comprising: (A) a low voltage full-bridge or half-bridge DC-AC converter; (B) an LLC resonant tank; (C) a high voltage AC-DC converter or rectifier and (D) optionally, a high voltage controllable switch; wherein the high voltage controllable switch is controllable to regulate power flow from an input to an output of the DC DC converter based on a externally determined input to output voltage gain ratio maintained by the high voltage controllable switch using frequency control, wherein the DC-DC converter includes (i) a resonant capacitor, (I) a resonant inductor, and (iii) a magnetizing inductor wherein the design method comprises: (i) determining a minimum gain sufficient to enable high-resolution control of frequency using available control hardware; (ii) selecting an Lₘ/Lᵣ ratio that is suitable for an application for the DC-DC converter (iii) generating voltage gain curves for various values of Q, and plotting these values so as to graph a boundary curve that defines LHS and RHS regions, and selecting the Q values whose voltage gain curve Intersects with boundary curve at the maximum voltage boost ratio, thereby defining a act of normalized frequency values; and (iv) using the Q values and the normalized frequency values found to calculate values for the resonant capacitor, the resonant inductor, and the magnetizing inductor so as to enable selection of suitable components for the application.

In another aspect of the invention, a method of designing a resonant DC-DC converter for high voltage boost ratio, the DC-DC converter comprising: (A) a low voltage full-bridge or half-bridge DC-AC converter (B) an LLC resonant tank; (C) a high voltage AC-DC converter or rectifier; and (D) optionally, a high voltage controllable switch; wherein the high voltage controllable switch is controllable to regulate power flow from an input to an output of the DI-DC converter based on a externally determined input to output voltage gain ratio. Power flow control is maintained using frequency control. The DC-DC converter Includes (i) a resonant capacitor, (ii) a resonant inductor, and (ill) a magnetizing inductor, wherein the design method comprises; (1) determining a minimum gin sufficient to enable high-resolution control of frequency using available control hardware; (2) selecting an Lₘ/Lᵣ ratio that is suitable for an application for the DC-DC converter; (3) generating voltage gain curves for various values of Q, and plotting these values so as to graph a boundary curve that defies LHS and RHS regions, and selecting the Q values whose voltage gain curve intersects with boundary curve at the maximum voltage boost ratio, thereby defining a set of normalized frequency values; and (4) using the Q values and the normalized frequency values found to calculate values for the resonant capacitor, the resonant inductor, and the magnetizing inductor so as to enable selection of suitable components for the application.

It is understood that the invention is capable of operating with other resonant converter configuration known in previous at and/or used in different applications. It is also understood that the invention is usable in applications with different grounding requirements including floating systems, high impedance grounded systems, and solidly grounded systems and that the use or not of a transformer may be influenced by the grounding requirements.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed here in are for the purpose of description and should not be regarded as limiting.

### BRIEF DESCRIPTION OF THE DRAWINGS

The invention will be better understood and objects of the invention will become apparent when consideration is given to the following detailed description thereof.

Such description makes reference to the annexed drawings wherein:

FIG. 1 is a circuit diagram illustrating a prior art buck converter.

FIG. 2 is a circuit diagram illustrating a prior art boost converter.

FIGS. 3(a), 3(b) and 3(c) illustrate three representative implementations of the half-bridge resonant DC-DC converter, having a single high voltage switch.

FIGS. 4(a) and 4(b) illustrate an implementation of a full-bridge resonant DC-DC converter.

FIGS. 5(a), 5(h), 5(c) and 5(d) illustrate four representative implementations of the full-bridge resonant DC-DC converter of the present invention, having a single high voltage switch and a common ground on the Input and the output.

FIGS. 6(a), 6(b) and 6(c) illustrate the three representative circuits of an alternate implementation of the circuit design of the present invention that include transformer.

FIG. 7 is the implementation of FIG. 6(c), using MOSFET switches, with the addition of a snubber diode.

FIG. 8 illustrates the voltage and current waveforms associated in operation with the circuit of FIG. 7.

FIG. 9 is a specific implementation of the half-bride resonant DC-DC converter of FIG. 3(a) using a combination of MOSFET and IGBT switches.

FIG. 10 illustrates the voltage and current waveforms associated in operation with the circuit of FIG. 9.

FIG. 11 is a specific Implementation of the full-bridge resonant DC-DC converter of FIG. 5(a) using a combination of MOSFET and IGBT switches, with the addition of a snubber diode.

FIG. 12 illustrates the voltage and current waveforms associated in operation with the circuit of FIG. 11.

FIGS. 13(a) and 13(b) are circuit diagrams illustrating alternate implementations of the full-bridge resonant DC-DC converter of the present invention, with a common ground for the input and the output, but without a high voltage switch.

FIGS. 14(a), 14(b) and 14(c) are a circuit diagrams illustrating a possible LLC converter circuit designs, that am (A) operated in a novel and innovative way based on the methods of the present invention, and (B) redesigned also as described in this disclosure.

FIG. 15 illustrates a classic LLC circuit equivalent model used for First Harmonic Approximation (FHA) analysis.

FIG. 16 illustrates the voltage gain, computed from FHA, achieved with an LLC circuit topology with various loads over a large range of switching frequencies.

FIG. 17 illustrates the voltage gain, computed from FHA, achieved with an LLC circuit topology with various loads over a large range of switching frequencies with the conventional region of LLC operation and the Interrupt Switch Control Region denoted.

FIG. 18 illustrates the voltage sin achieved with an LLC circuit topology with various loads over a large range of switching frequencies with a number of operating regions denoted: (1) RHS Operation region, (2) LHS Operation region, (3) Conventional Operation region and (4) the LHS/RHS Boundary curve.

FIG. 19 illustrates a voltage gain graph of the LLC converter operated at constant gain with power flow regulated by adjusting the switching frequency.

FIG. 20 illustrates how conventional LLC resonant converters control their voltage boost, and therefore, their power flow.

FIG. 21 illustrates an LLC tank current waveform using an interrupt switch in accordance with another aspect of the present invention.

FIG. 22 illustrate an LLC tank current operating near full power in accordance with another aspect of the present invention.

FIG. 23 illustrates an LLC tank current operating at low power in accordance with another aspect of the invention.

FIGS. 24(a), 24(b). 24(c) and 24(d) illustrate four representative implementations of the resonant DC-DC converter of the present invention with externally determined input and output voltages and no interrupt switch, where FIGS. 24(b) and 24(c) further illustrate representative bi-polar output configuration and 21(d) further illustrates a possible implementation with auto-balancing bi-polar output voltages.

FIG. 25 illustrates the voltage gain achieved with an LLC circuit topology with various loads over a large range of switching frequencies with LHS/RHS Boundary curve denoted.

FIGS. 26(a) and 26(b) show the general form of the current invention with and without an interrupt switch.

FIG. 27 illustrates voltage gain curves for the LLC converter focused around a voltage gain of 4 in accordance with an embodiment.

FIG. 28 illustrates a final converter design in accordance with an embodiment, with the region of operation identified.

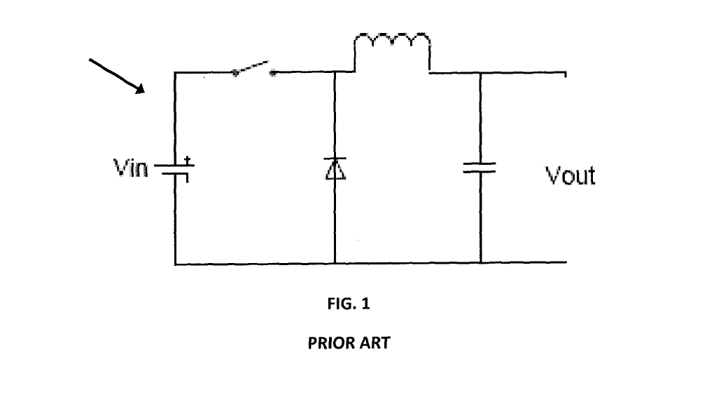

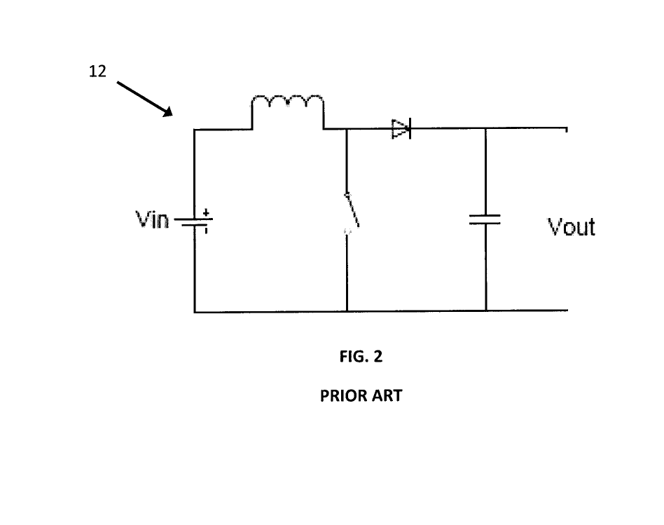

In the drawings, embodiments of the invention are illustrated by way of example. It is to be expressly understood that the description and drawings are only for the purpose of illustration and as an aid to understanding, and are not intended at a definition of the limits of the invention.

### DETAILED DESCRIPTION

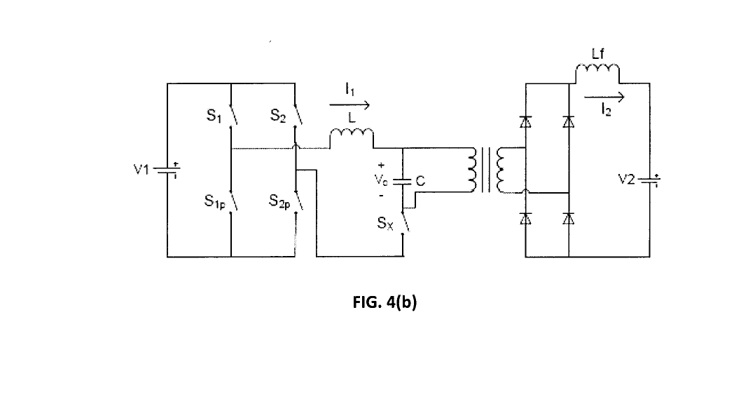

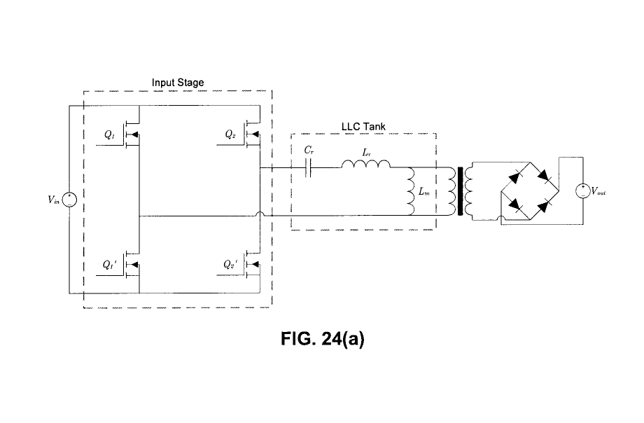

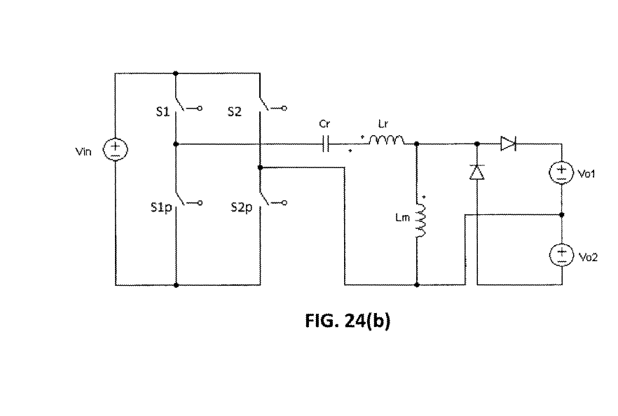

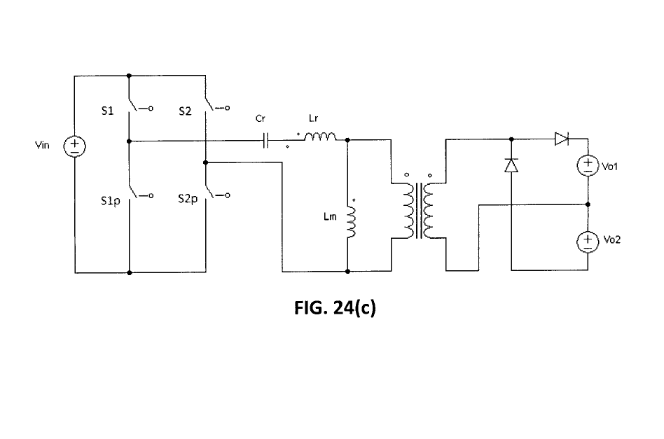

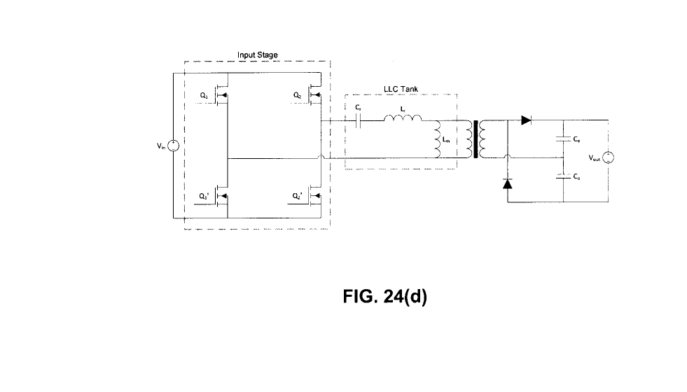

The present invention describes a number of innovations related to the subject matter of the Base Application. The present invention includes (A) a novel and innovative resonant DC-DC converter that employs a high boost resonant tank to enable power flow control between externally determined input and output voltages using frequency control, with or without use of an interrupt switch (the “Improved DC-DC Converter”), (B) a method of operating a resonant DC-DC converter to achieve high boost resonant tank operation, which is suitable for improving the performance of resonant converters based on different topologies (“method of operation”), including but not limited to the Improved DC-DC Converter; and (C) a method for designing DC-DC converters (having different topologies) for improved performance using the method of operation (“design method”). The design method includes identification of circuit design parameters that enable use of the method of operation. Performance improvements include improved resolution of power flow control between externally determined input and output voltages and maximization of range of allowable voltage conversion ratio, while meeting a specified power flow. Operation of the converter ova a reduced range of frequencies may also allow circuit components to be better optimized for efficiency. In full-bridge embodiments, as exemplified in FIG. 4, the use of uni-polar/bi-polar operation may allow enhancement of circuit efficiency over portions of the operating range. In embodiments such as FIG. 24(d) the provision of a bi-polar auto-balancing output voltage eliminates need for advanced sensing and controls to achieve voltage balancing in the bi-polar output.

For example, use of the embodiment of FIG. 24(d) for solar photovoltaic applications, enables the design of a high voltage boost DC-DC Converter that offers inherent safety through low-voltage operation of the photovoltaic modules, distributed control for increased energy yield, high-conversion efficiency over a wide range of input voltages and power flows, integrated galvanic isolation to isolate faults, use of long-life film capacitors, and full utilization of the AC grid interconnection inverter.

There are related patent applications to the Base Patent including PCT/CA2011/000185, filed Feb. 18, 2011, claiming priority to United States patent application No. Mar. 18, 2010 (the “Related Patents”). Certain details of the Related Patents are restated here to aid in understanding of the invention. More particularly the disclosure discusses DC-DC converters that include an interrupt switch and also that do not include an interrupt switch, because aspects (B) and (C) of the invention are relevant to both types of circuits.

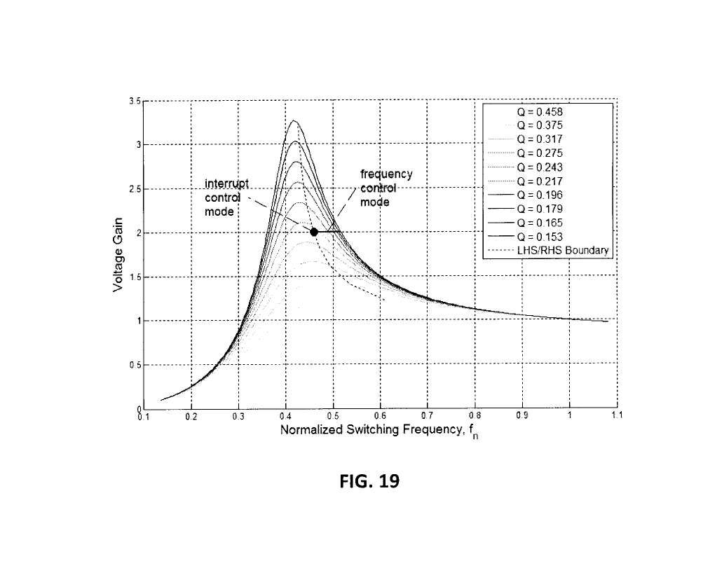

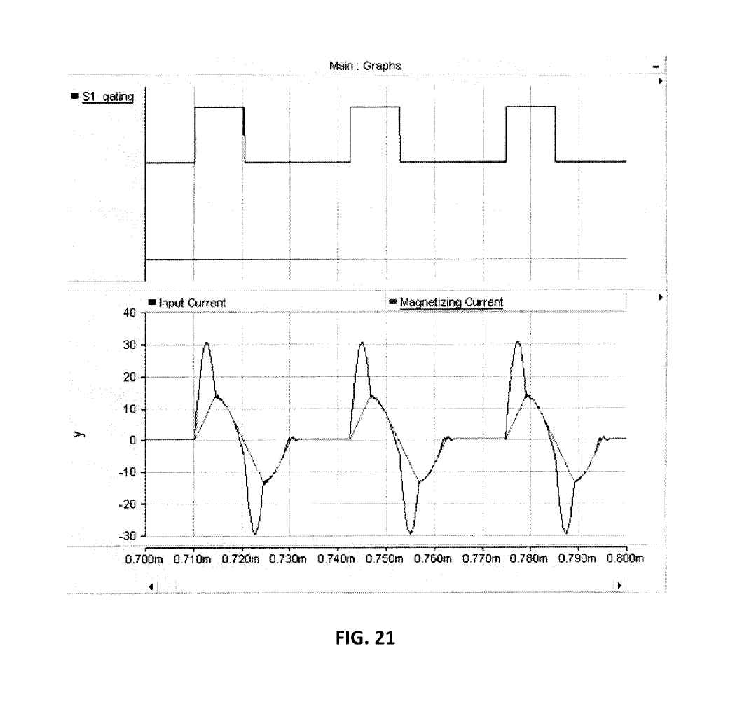

One aspect of the invention is a resonant converter circuit design operable to achieve high input-to-output voltage conversion. In particular the invention may include a series of converter circuit topologies that provide high resonant tank boot ratio and achieve high efficiency operation. The converter circuit topologies may include a resonant tank and (in one aspect) a means for interrupting the tank current to produce a near zero-loss “hold” state wherein zero current and/or zero voltage switching is provided, while providing control over the amount of power transfer. Specifically the converter circuit topologies may control energy transfer by controlling the duration of the near zero-loss “hold”. This may be referred to as the “Interrupt control mode” (again, shown for example in FIGS. 19 and 21) This energy power transfer control may be achieved using a single high voltage controllable switch.

The present invention may avoid unnecessary circulating current during low power operation, thereby reducing losses within the tank components and the low voltage DC/AC converter, and also reducing switching losses based on the zero voltage switching of the low voltage DC/AC converter and zero current switching of the low voltage DC/AC converter. Also, are current switching of the high voltage controllable switch within the tank may be achieved and thereby keep its own switching losses low.

As described herein, the present invention may have several embodiments that present converter circuit topologies that provide high input-to-output voltage conversion and achieve high efficiency operation. Examples of these embodiments are disclosed herein; however a skilled reader will recognize that these examples do not limit the scope of the present invention and that other embodiments of the preset invention may also be possible.

For clarity, the term “low voltage” is used in this disclosure to refer to components with voltage ratings comparable to that of the input, and the term “high voltage” is used in this disclosure to refer to components with voltage rating comparable to, or above, the peak voltage level seen across the resonant tank capacitor.

In embodiments of the peasant invention, appropriate implementation of the near zero-loss hold state, may cause zero voltage switching or zero current switching to be achieved for all controllable switches within the circuit.

Embodiments of the present invention may provide a lower loss converter circuit for high input-to-output voltage convention ratio converters.

A skilled reader will understand that the circuit design of the present invention may include a variety of elements. In one embodiment these elements may include: (1) an input DC/AC converter; (2) a resonant tank; (3) a tank interruption means (such as a switch as described herein); and (4) an output rectifier. The output rectifier may, for example, include a filter inductor that limits the rate of rise of current in the output diode. Regarding the input DC/AC, a skilled reader will recognize that a number of different types of inverters may be suitable, for example, such as a half-bridge or full-bridge type inverter. A skilled reader Ill further recognize that the output rectifier may include any output rectifier stage, for example, such as a half-bridge or full-bridge rectifier. In some embodiments of the present invention, a transformer may be included in the circuit, prior to the output rectification stage.

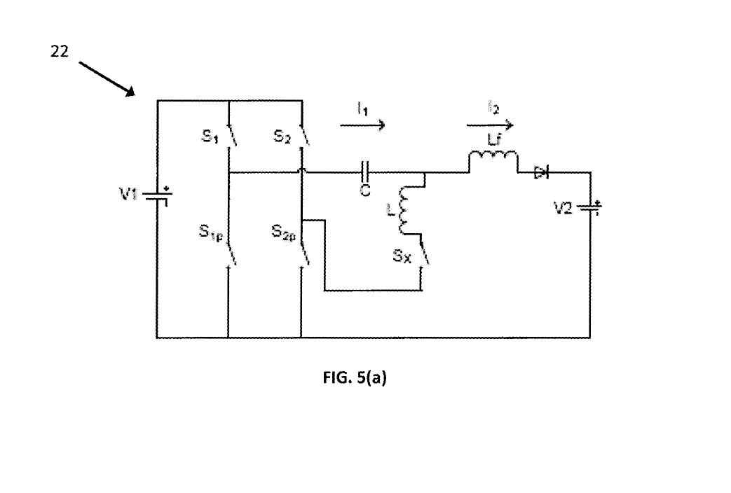

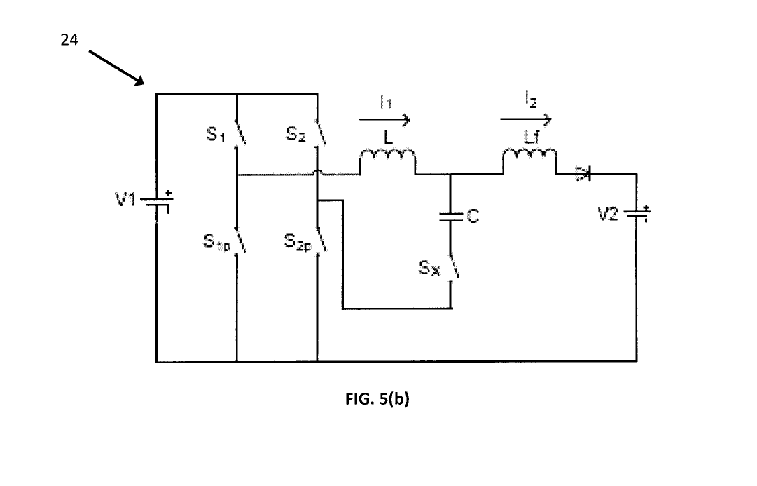

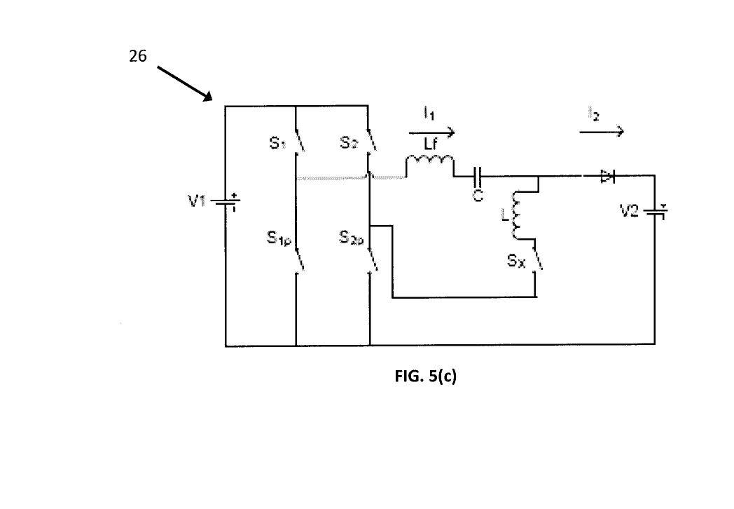

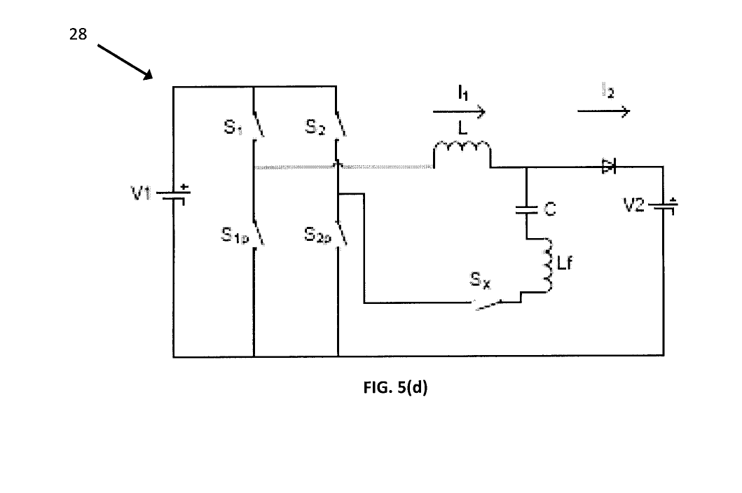

In one embodiment of the present invention, the circuit design may be a circuit that includes: (1) a full-bridge DC/AC converter, (2) a resonant tank consisting of two L components and one C component; (3) a tank interruption switch; and (i) an output rectifier stage (full-bridge or half-bridge), wherein a common ground may be provided for both the input voltage and the output voltage. Possible embodiments of the present invention that include such a circuit design are shown in FIGS. 5a to 5d.

The circuit may, or may not, include a transformer. In an embodiment of the present invention wherein a full-bridge output rectifier is utilized a transformer may also be required. In an embodiment of the present invention that includes a transformer, the resonant L components may be integrated into the transformer design. The choice to Include a transformer in an embodiment of the present invention may be based on specifications of the circuit of the embodiment of the present invention, or other preferences or considerations. This document discloses and describes some examples of both: embodiments of the present invention that include a transformer element; and embodiments of the present invention that do not include a transformer element, and therefore are a transformerless.

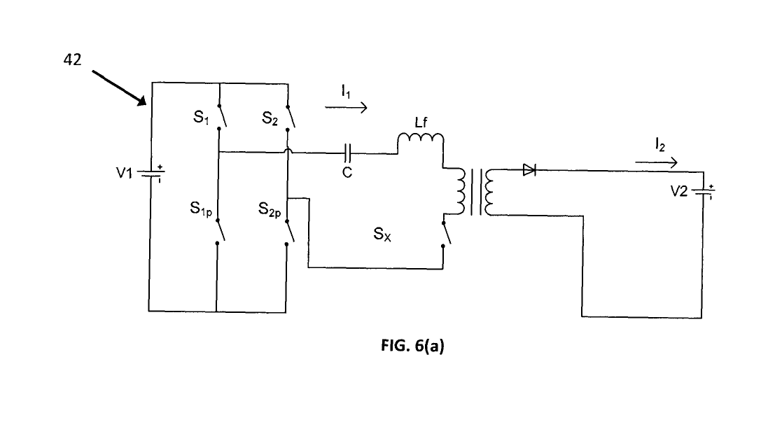

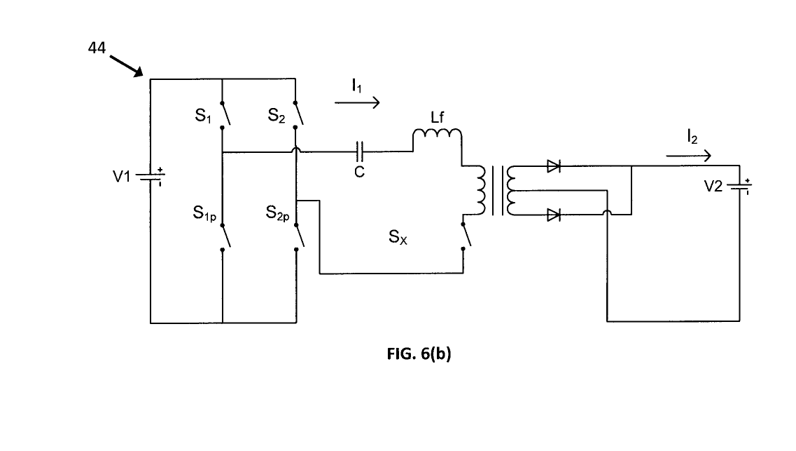

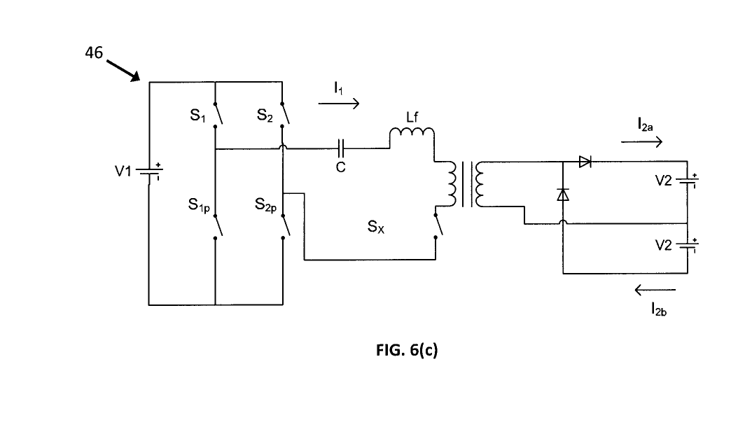

FIGS. 6(a), 6(b) and 6(c) show embodiments of the present invention that the circuits 42, 44 and 46 respectively, that include an alternate implementation, wherein additional windings were added to the main inductor's magnetic core dins decreasing the voltage stress on switch Sₓ. The addition of windings may convert the inductor L into a transformer with isolation, which provides additional circuit implementation options. The embodiment of the present invention shown in FIG. 6(c) may provide bipolar output to allow a differential output voltage of 2×V₂ to be achieved while maintaining a voltage to ground at level V2.

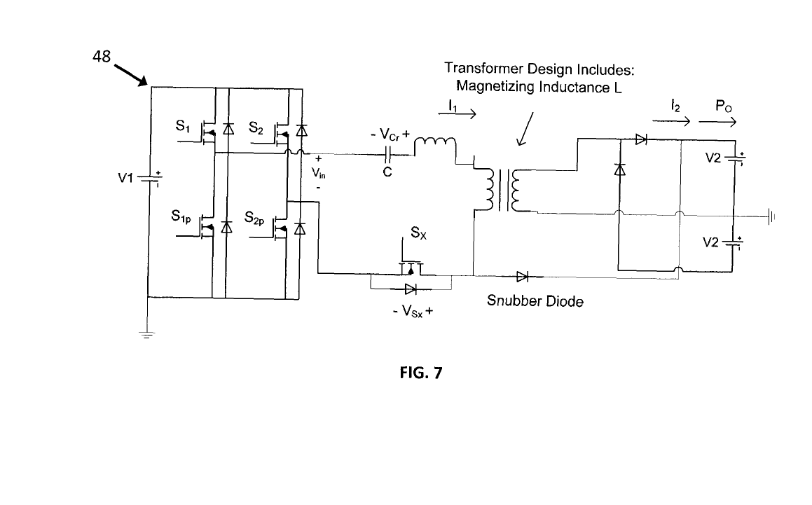

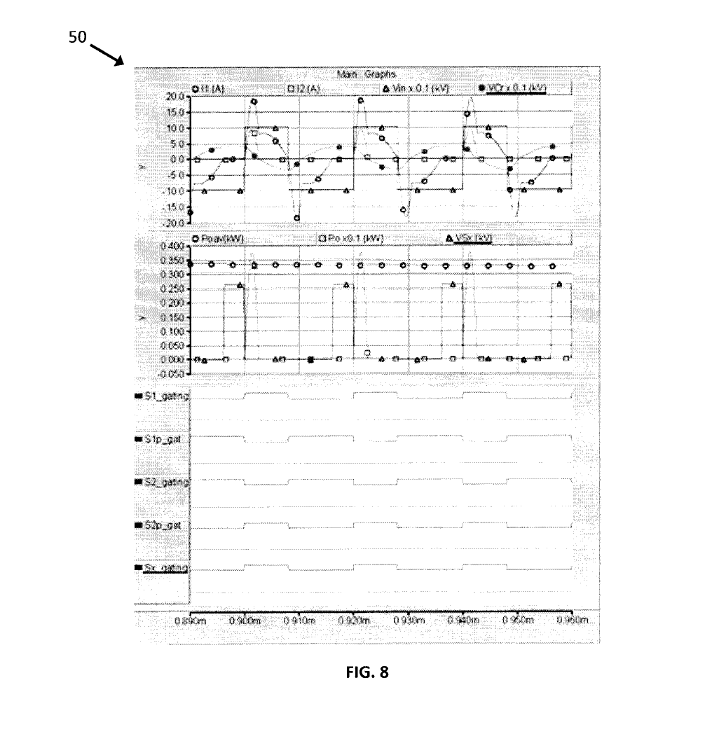

As shown in FIG. 7, a circuit 48 may be one practical implementation of the circuit shown in FIG. 6(c). The transformer magnetizing branch may provide the main resonant tank inductance “L”. Through appropriate transformer design, the filter inductance “L_{f}” may also be integrated into the transformer. This may be done by designing the transformer to have leakage inductance of value “L_{f}”. As shown in FIG. 7, all switches may be implemented using MOSFETs. A snubber circuit may be employed to limit the transient voltage across the high voltage MOSFET at the end of the conduction period. Provided the voltage V₂ is low er than the voltage rating of the high voltage MOSFET, the snubber may consist of a single diode from the drain of the MOSFET to the positive output V₂. This may allow energy normally lost in snubber circuitry to be transferred to the output, thereby yielding a near loseless snubber. This may improve overall converter efficiency.

As shown in FIG. 8, embodiments of the present invention may produce particular results 50 that include gating signals for the converter of FIG. 7, together with the important voltage and current waveforms. The following is a description of a possible switching cycle method:
1. At time 0.900 ms the cycle may begins with the turn of on of switches S₁, S₂ₚ and Sₓ. Thereafter energy may be transferred into the resonant tank as seen by the positive voltage Vᵢₙ and positive tank input current I₁.
2. When the tank current I₁ reaches mer switches S₁ and S₂ₚ, may turn off, almost immediately after which switches S₂ and S₁ₚ may turn on. This nay case the input voltage polarity to become negative at the same time that the current becomes negative.
3. Switch Sₓ may turn off at the same time as S₁ and S₂ₚ, though the MOSFET body diode may allow conduction of the negative current. If losses in the MOSFET conduction channel are calculated to be lower than body diode conduction losses, then the MOSFET should be kept on for the duration of the negative current pulse to reduce conduction losses.
4. When the current reaches zero the switch Sₓ must be off. This may interrupt the tank current and allow the circuit to enter a near zero loss “hold state” where the converter operation is suspended and held in a near lossless state.
5. The duration of the hold state may be varied to control the amount of average power transfer from input to output. Following the hold state another similar cycle of operation may follow.

Transfer of power from the resonant tank to the output may occur twice jar period, once to the positive DC output, once to the negative DC output. Power transfer to the positive output may take place immediately after the turn on of switches S₁ and S₂ₚ. Power transfer to the negative output may take place immediately after the turn on of switches S₂ and Sₜₚ.

In one embodiment of the present invention, a circuit may be provided consisting of a DC-AC converter followed by a (parallel) resonant tank with single controllable high voltage switch, followed by an AC-DC converter.

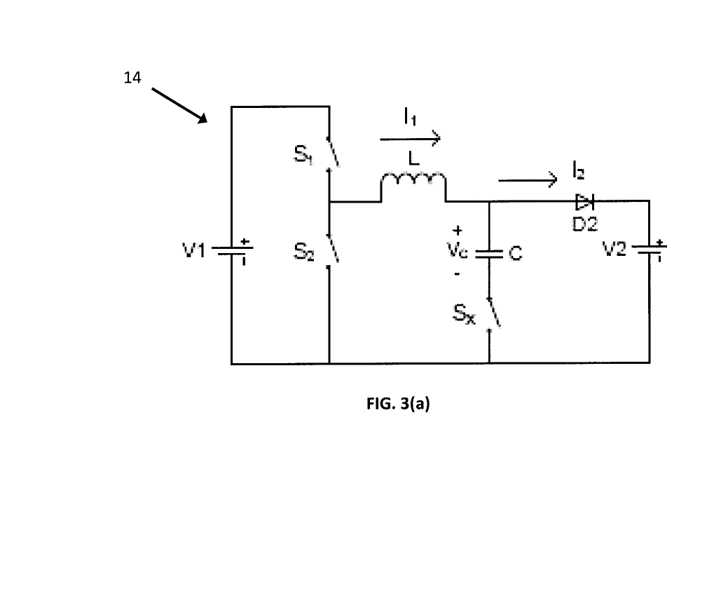

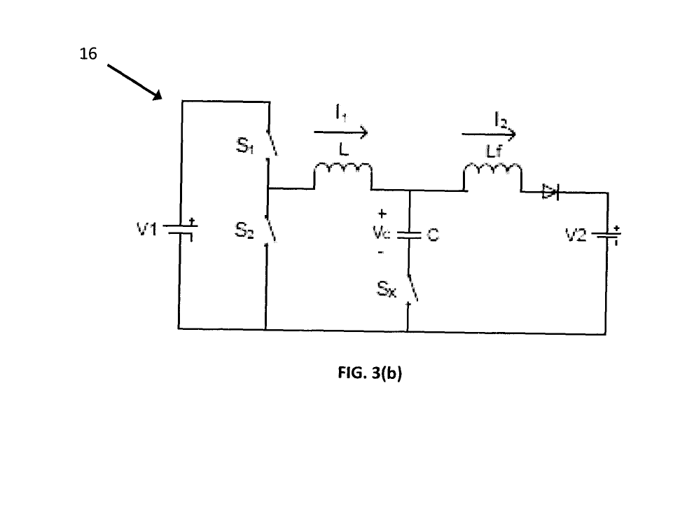

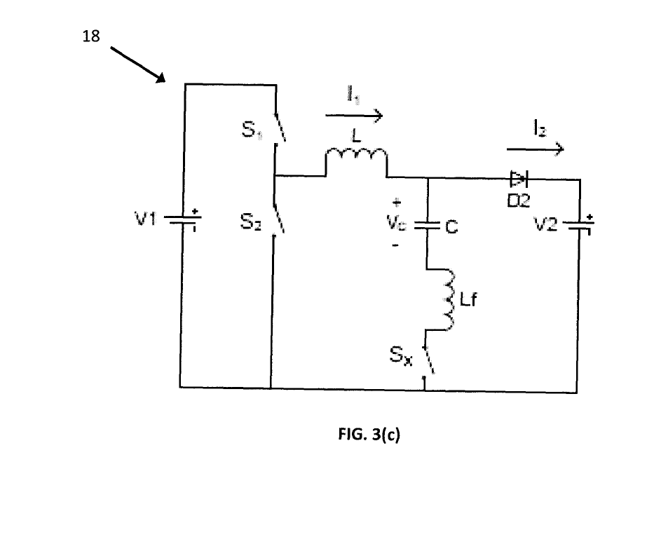

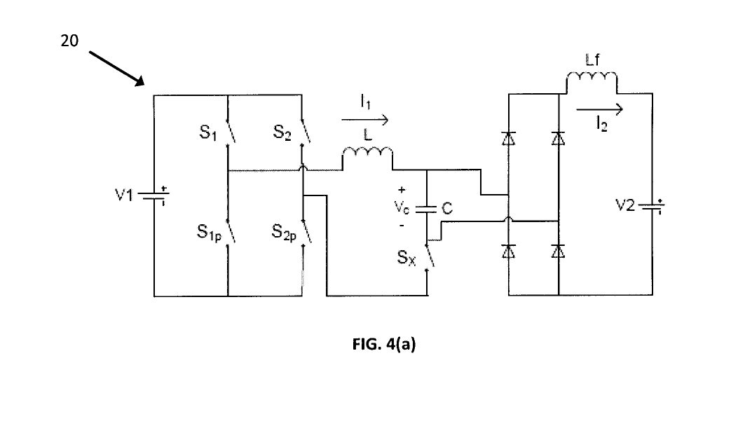

Embodiment of the present invention that includes the proposed “half-bridge floating tank” resonant DC-DC converter configuration are shown in FIGS. 3(a), 3(b) and 3(c) in tree specific representative implementations. The embodiment of the present invention shown in FIG. 3(a), may be a circuit 14 that does not include an output filter inductor. FIG. 3(a) illustrates the basic circuit design concept of the present invention, and presents a half-bridge floating tank converter in accordance with the present invention. The embodiment of the present invention shown in FIG. 3(b) may be a circuit 16 that includes an output filter inductor. For most implementations of the invention, it is a practical requirement to include a filter inductor. Generally speaking, there are two locations where it is convenient to add the filter inductor, the first is illustrated in FIG. 3(b). The second is shown in FIG. 3(c), which shows an embodiment of the present invention that may be a circuit 18 that includes a filter inductor integrated in the tank.

As shown in FIG. 4(a), in one embodiment of the present invention the circuit 20 may be a “full-bridge floating tank” configuration of the circuit design illustrated in FIGS. 3(a), 3(b), and 3(c). FIG. 4(a) may be extension of the converter illustrated in FIGS. 3(a), 3(b) and 3(c). A skilled reader will recognize that the circuit 20 shown in FIG. 4(a), relative to the circuits 22, 24, and 26 shown in FIGS. 5(a), 5(b), 5(c), and 5(d) respectively, for example, may lack a common ground on the input and the output and therefore may be undesirable for many transformerless applications. In embodiments of the present invention an isolation transformer may be added between the capacitor and the diode rectifier, to allow grounding of both the input and output voltage sources.

Embodiments of the present invention, as shown in FIGS. 5(a), 5(b), 5(c) and 5(d), may represent variants of the full-bridge resonant DC-DC converter of the present invention, and may include a single high voltage switch, and a common ground for the input and the output. More specifically: the embodiment of the present invention shown in FIG. 5(a), may be a circuit 22 wherein the inductor current may be switched by the single high voltage switch (Sₓ); the embodiment of the present invention shown in FIG. 5(b), may be a circuit 24 wherein the capacitor current may be switched by the single high voltage switch (Sₓ); the embodiment of the present invention shown in FIG. 5(c), may be a circuit 26 that is similar to the circuit 22 shown in FIG. 5(a), and the circuit 26 shown in FIG. 5(c) may include a inductor current that may be switched by Sₓ and the filter inductor may be integrated into the tank; and the embodiment of the present invention shown in FIG. 5(d), may be similar a circuit 28 that is similar to the circuit 24 shown in FIG. 5(b), and the circuit 28 shown in FIG. 5(d) may include a capacitor current that may be switched by Sₓ and the filter inductor may be integrated into the tank.

It should be understood that the DC-DC converter of the present invention as shown in FIGS. 5(a), 5(b), 5(c) and 5(d), relative to prior art full-bridge extensions of half-bridge circuits, may display a significant degree of asymmetry. In particular the asymmetry may be displayed in that the grounding is asymmetric, the input switch configuration is asymmetric, and the output stage is asymmetric.

A skilled reader will recognize that other variants and embodiment of the present invention are possible. For example an embodiment of the present invention may use emerging reverse block IGBT devices, in which case Sₓ may be eliminated, but S₁ and S₂ may each need to consist of a high voltage reverse blocking IGBT. Such an embodiment of the present invention may yield precisely the same voltage and current waveforms within the tank and output circuitry. Numerous other variations are possible.

In an embodiment of the present invention, the circuit design may be such that the high voltage switch needs not be reverse blocking, and thus MOSFET or IGBTs may be used instead of, for example, thrysitors (which limit switching frequencies to excessively low values), or MOSFET-series-diode/IGBT-series-diode combinations.

Also, in embodiments of the present invention, the circuit designs may use an electrically floating tank, as further explained below.

Certain aspects of the invention are explained in greater detail below, however theme details should not be read as limiting the scope of the invention in anyway, but as examples of embodiments of the present invention.

### The Half-Bridge Floating Tank Converter

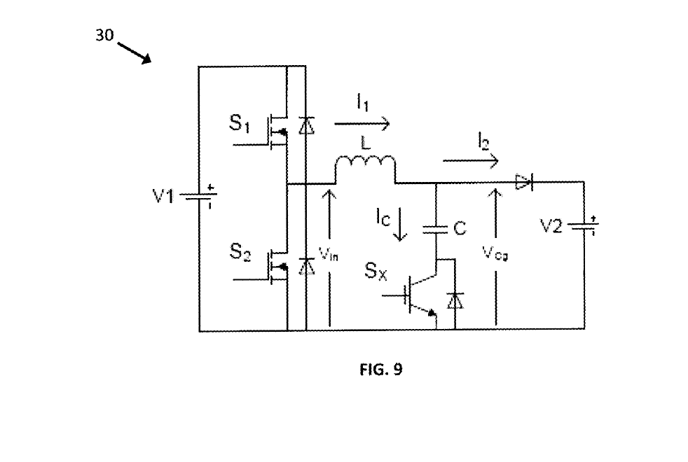

The half-bridge floating tank converter may be included in embodiments of the present invention. In such an embodiment of the present invention, the switching process may very slightly based on the type of switches used and the location/orientation of the high voltage switch (Sₓ) within the tank circuit. A description of a possible switching process to be used in an embodiment of the present invention is provided herein with reference to a topology 30 wherein S₁ and S₂ are implemented using MOSFETs and Sₓ is implemented using a high voltage IGBT, as shown in FIG. 9.

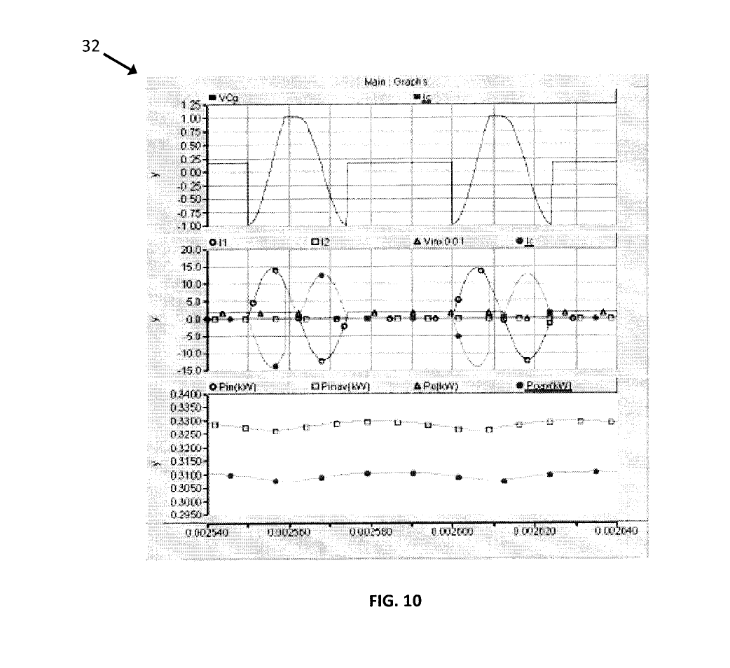

In one embodiment of the present invention, as shown in FIG. 10, waveform results 32 of use of the embodiment may show particular voltage and current waveforms associated with a half-bridge floating tank converter. For example, the converter may operate in a mode where the inductor current is not continuously oscillating but is interrupted, once each period, by the single high voltage switch, Sₓ.

An example of the operation of the circuit may be as follows:
1. S₁ and Sₓ may fire to begin one cycle of LC resonant oscillation. For the given orientation of the IGBT (Sₓ), the initial condition on the capacitor voltage may be approximately −V₂.
2. Current I1 may be positive and input voltage Vᵢₙ may be positive for half a cycle transferring energy into the circuit.
3. Once V_{cg} reaches V₂, the output diode conductors and I1 may be transferred to the output, accomplishing output power transfer (the rapid rate of rise of the output current may be reduced through introduction of an additional current-rate-change limiting inductor placed either in series with the output diode or the tank capacitor).
4. At zero crossing of the input current S₁ may be turned off and S₂ may be turned on. The output diode may turn off at this time and the IGBT reverse conducting diode may turn on at this time. This allows the tank oscillation to continue, thereby recharging the capacitor to −V₂, in preparation for the next cycle.
5. When the current I1 attempts again to go positive, the IGBT may be in an “off” state, thus Interrupting the tank oscillation at a current zero crossing
6. The circuit may then in a ‘hold state’ until a new pulse of energy is required.
   The Full-Bridge Floating Tank Converter with Common Ground

Embodiments of the present invention may include a full-bridge floating tank converter with common pound, as shown in FIG. 11. In such embodiments of the present invention the switching process may vary slightly based on the type of switches used and the location/orientation of the high voltage switch (Sₓ) within the tank circuit. One embodiment of the present invention include a full-bride floating tank converter with common ground may include a topology 34 where be four switches S₁, S₁ₚ, S₂ and S₂ₚ are implemented using MOSFETs and Sₓ is implemented using a high voltage IGBT, a shown in FIG. 11. In an embodiment of the present invention that includes a full-bridge floating tank converter with common ground, a snubber circuit may be employed to limit the transient voltage across the high voltage MOSFET at the end of the conduction period. The snubber may consist of a single diode from the collector of the IGBT to the output. This may allow energy normally lost in snubber circuitry to be transferred to the output, thereby yielding a near lossless snubber. Such embodiments of the present invention may improve overall converter efficiency.

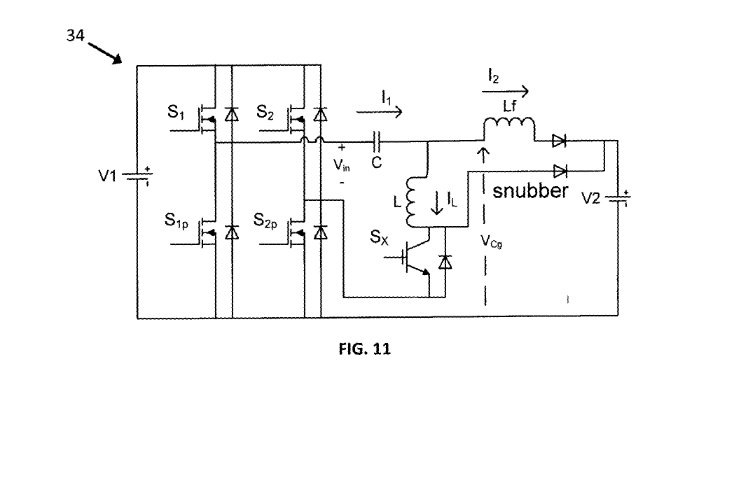

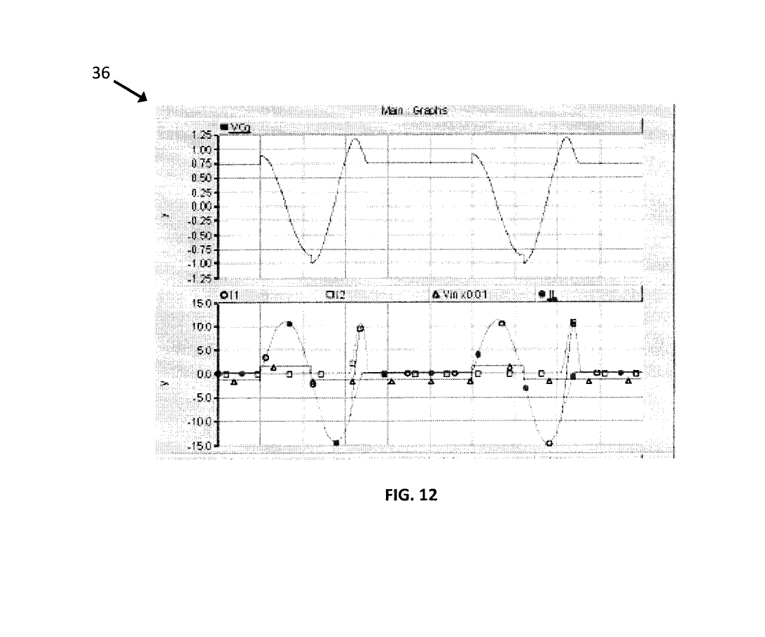

In one embodiment of the present invention, as shown in FIG. 12, waveform result 36 of use of the embodiment may show particular voltage and current waveforms associated with this a full-bridge floating tank converter with common ground. The converter may operable in a mode where the inductor current is not continuously oscillating but is interrupted, once each period, by the single high voltage switch, Sₓ.

An example of the operation of the circuit may be as follows:
1. For the given orientation of the IGBT (Sₓ), S₁, S₂, and Sₓ may fire to be in one cycle of LC resonant oscillation.
2. Current I₁ may be positive and input voltage Vᵢₙ may be positive for half a cycle, transferring energy into the circuit.
3. When I₁ crosses S₁, S₂ₚ may turn off and S₂ and S₁ₚ may turn on. Sometime during negative I₁ the switch Sₓ may be turned off losslessly since the current is flowing in the anti-parallel diode.
4. When V_{eg} reaches V₂ power may begin being transferred to the output. This may continue until the current I₂ decays to zero.
5. Capacitor voltage may then be in a ‘hold state’ until a new pulse of energy is required.
   The Full-Bridge Converter with Common Ground and Silicon Carbide Devices

Embodiments of the present invention may include a full-bridge floating tank converter with common ground that is operable to transfer energy during both positive and negative half cycles of the tank current, without use of a transformer, while maintaining a common round on input and output, as required for many applications. The purpose of Sₓ in this circuit may be to achieve zero current/zero voltage switching while still offering control over the amount of power transfer. Thus near zero switching loan may be achieved while simultaneously maintaining control over the amount of power transfer.

As silicon carbide switching devices, or other devices with low reverse recovery loss, become more cost effective it may become worthwhile to eliminate Sₓ.

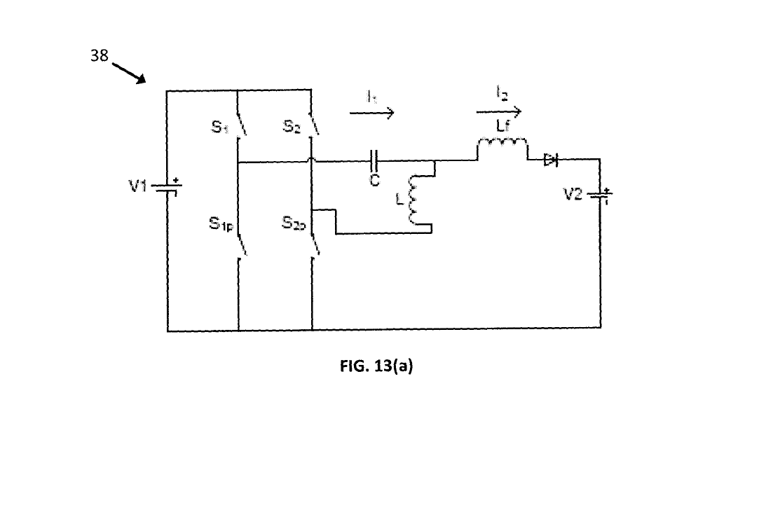

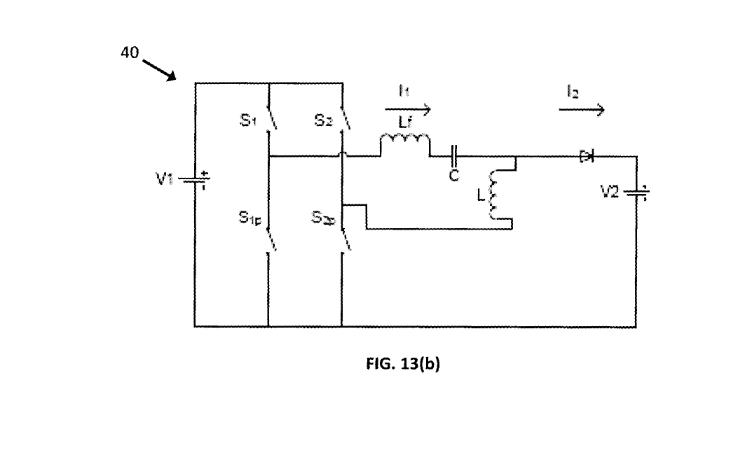

Nonetheless, a common ground arrangement capable of transferring energy during both positive and negative half cycles of the tank current may still be desired. The circuit topologies 38 and 40 of FIGS. 13(a) and 13(b) accomplish this. These topologies may be related to the circuit designs shown in FIGS. Sa and Sc. As silicon carbide devices may offer greatly reduced switching losses (esp. the elimination of diode reverse recovery current), maintaining zero current/zero voltage switching may be sacrificed without negatively impacting efficacy. Power transfer may then be achieved via frequency control, as is common in other resonant converters, see R. Erickson, D. Maksimovic, “Fundamentals of Power Electronics,” Kluwer Academic Publishers, 2001.

The full-bridge converter with common ground may offers important benefits compared to the conventional resonant converters as outlined in R. Erickson, D. Maksimovic. “Fundamentals of Power Electronics,” Kluwer Academic Publishers, 2001. Specifically the topology of an embodiment of the present invention that includes a full-bridge converter with common ground may offer common ground on input and output along with a high step-up ratio and may offer power transfer into the tank during both positive and negative half cycles of the tank current.

As examples of embodiments of the present invention and the benefits that these offer over the prior art, benefits of particular features of two principal circuit arrangements (a half-bridge floating tank converter, and a full-bridge floating tank converter with common ground) over the prior art are described below. A skilled reader will recognize that the features and benefits discussed below are merely provided as examples, and other embodiments and benefits are also possible.

### Benefits of the Half-Bridge Floating Tank Converter;

Embodiments of the present invention that include a half-bridge floating tank converter may offer particular benefits over the prior art. Some of these benefits include the following.
1. In comparison to the circuit of A. Abbas, P. Lehn, “Power electronic circuits for high voltage DC to DC converters,” University of Toronto, Invention disclosure RIS#10001913, 2009-03-31, or that of D. Jovcic, “Step-up MW DC-DC converter for MW sire applications,” Institute a Engineering Technology, paper IET-2009-407, the half-bridge circuit of the present invention may only use one high voltage device, labelled: Sₓ. Furthermore Sₓ may not need to be a reverse blocking device.
2. A single high voltage switch may be operable in embodiments of the present invention to interrupt the resonant operation of the converter, thereby controlling energy transfer.
3. S₁ and S₂ may be implemented in embodiments of the present invention using only low voltage components, reducing losses.
4. In comparison to the invention of B. Bui, P. Bartal, I. Nagy, “Resonant boost converter operating above its resonant frequency,” EPE, Dresden, 2005, embodiments of the present invention may only require a single source and single tank Inductor.
5. Embodiments of the present invention may provide zero current/zero voltage switching of the input AC-DC converter.
   Benefits of the Full-Bridge Floating Tank Converter with Common Ground

Embodiments of the present invention that include a full-bridge floating tank converter with common ground may offer particular benefits over the prior art. Some of these benefits include the following:
1. In comparison to the circuit of A. Abbas P. Lehn, “Power electronic circuits for high voltage DC to DC converters,” University of Toronto, Invention disclosure RIS#10001913, 2009-03-31, or that of D. Jovcic, “Step-up MW DC-DC converter for MW size applications,” Institute of Engineering Technology, paper IET-2009-407, the circuit of embodiments of the present invention may operate using only one high voltage device, labeled Sₓ, as shown in FIGS. 3(a), 3(b). 3(c), and 3(d). Furthermore Sₓ may not need to be a reverse blocking device.
2. In comparison to the circuit of P. Lehn, “A low switch-count resonant dc/d converter circuit for high input-to-output voltage conversion ratios,” University of Toronto, Invention disclosure RIS#10001968, 2009-08-13, or the half-bridge circuit of the present invention, the full-bridge DC-DC converter of embodiments of the present invention may provide roughly double power transfer since energy may be transferred from the source into the tank during both positive and negative half cycles of the tank current.
3. Embodiments of the present invention may provide size current/zero voltage switching of the input AC-DC converter.
4. In embodiments of the present invention common ground may be provided between the input voltage source and output voltage source.
5. In embodiments of the present Invention a single high voltage switch way be operable to interrupt the resonant operation of the converter, them by controlling energy transfer.

A skilled reader will recognize that numerous implementations of the technology of the present invention are possible. The circuit designs of embodiments of the present invention may present a modular structure and therefore components may be added or removed, while providing the functionality of the design, as described above. For example, particular embodiments at the DC-DC converter of the present invention may be transformerless. In other embodiments of the present invention it may be desirable to include a transformer in the circuit, such as the circuit shown in FIG. 4(b). For example, a transformer could be included between either the resonant tank inductor or resonant tank capacitor and the diode rectifier in the circuit shown in FIG. 4(b). Also, while use of Sₓ is described for some embodiments of the present invention, this component may be eliminated by, for example, using emerging reverse block IGBT devices, where S₁ and S₂ would each need to consist of a high voltage reverse blocking IGBT.

### Variants

A skilled reader will recognize that in embodiments of the present invention specific aspects of the topologies described and shown herein may be modified, without departing from the essence, essential elements and essential function of the topologies. Pr example, in the circuit design 42 shown in FIG. 6(b), if L_{f} and C are in series with no midpoint, it may be possible to swap Lᵣ and C. Similarly, when used with a transformer, any number of known output winding and rectifier configurations may be applied to achieve the same objective.

In one embodiment of the present invention the switching elements, for example as shown in the FIG. 13(b) may employ silicon carbide devices. Switching nay be carried out to provide a square wave voltage switching between +V1 and −I1 to the tank circuit. The switching carried out to provide a square wave voltage may be switching between +V1 and 0 (or between 0 and −V1) to the tank circuit Tank input voltage switching may occur between +V1 and −V1 when operating near rated power and between +V1 and 0 (or between 0 and −V1) under low power. Alternatively, the elements recited in this paragraph may be used in a topology where the inductor Lf is moved to the output path (such as is shown in FIG. 13a).

### Voltage Boost Resonant Tank Converter

The inventors have realized DC-DC converters may be provided that include improved performance characteristics of the DC-DC converters disclosed above, however, without the interrupt switch disclosed in the Base Patent.

More particularly, in another aspect of the present invention, it has been realized by the inventors that it is also possible to build a desired resonant DC-DC converter for providing a high voltage step-up ratio without employing a tank interruption switch Sₓ as exemplified by the circuit topologies 38 and 40 of FIGS. 13(a) and 13(b). More generally, this is achieved by employing a number of concepts including: (i) achieving a high boost through the systematic design of a resonant tank; (ii) enhancing converter efficiency using a unipolar/bipolar resonant tank excitation; and (ill) employing an output configuration with automatic voltage balancing on output capacitors in conjunction with the high boosting resonant tank circuit to yield a high step-up ratio and a balanced bipolar DC output voltage.

More specifically, it is possible to achieve a high boost ratio from the resonant tank through the careful selection of resonant components. An illustrative example Is shown in FIG. 24(a) where an LLC converter circuit design in accordance with an embodiment does not require a high voltage switch. Here, Cᵣ represent a resonant capacitor, Lᵣ represents a resonant Inductor, and Cₘ represents a magnetizing inductor.

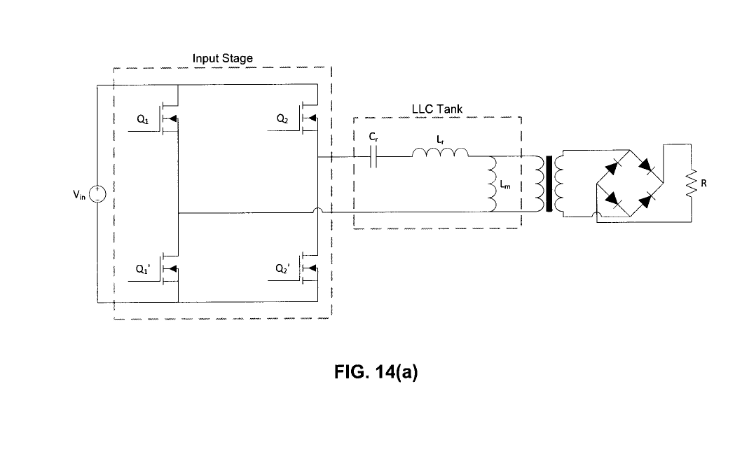

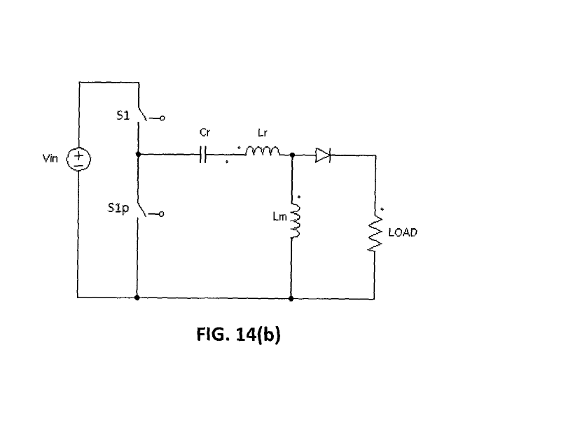

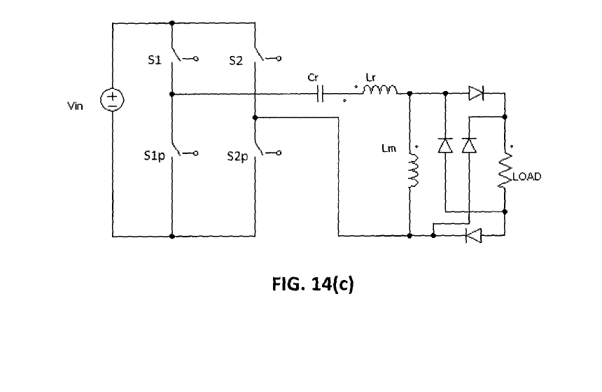

The “Classic” LLC Circuit DC-DC converter topologies shown in FIG. 14 have been studied in literature (R. L. Lin et. al. and H. Hu et. al., above), however most of the prior art is related to step down (buck) realizations of the technology. This type of converter design is commonly used in conventional applications where the output voltage is independent of the load, such as a power supply. In these applications, the classic LLC circuit topology offers advantages compared to other circuit topologies. To illustrate the functioning of the circuit, the voltage pin characteristics of the LLC converter can be approximated using first harmonic approximation (FHA) techniques. Assuming the circuit is stimulated by a perfect sinusoid, one can use conventional circuit analysis to determine the voltage gain of the circuit.

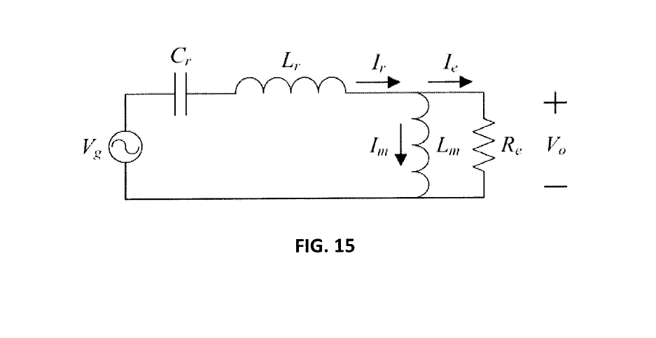

An LLC converter as illustrated in FIG. 14(a) for example may be simplified to provide the circuit shown in FIG. 15 here Re is the equivalent resistance for the resonant tank. This equivalent resistance depends on the type of rectifier used. For the full bridge this may be Re=8R/π² [discussed for example in H. Huang, above.] where R is the DC load resistance across the full bridge rectifier output.

It can be shown that the voltage gain of the circuit is defined by:

$$M = \frac{{V}_{out}}{{V}_{in}} = \vert \frac{α {f}_{n}^{2}}{α {f}_{n}^{2} + ( {f}_{n}^{2} - 1 ) ( 1 + {if}_{n} α {Q}_{n} )} \vert \qquad ( 1 )$$

### Where

$$\begin{matrix}α = \frac{{L}_{m}}{{L}_{r}} & ( 2 ) \\ {f}_{n} = \frac{f}{{f}_{0}} & ( 3 )\end{matrix}$$

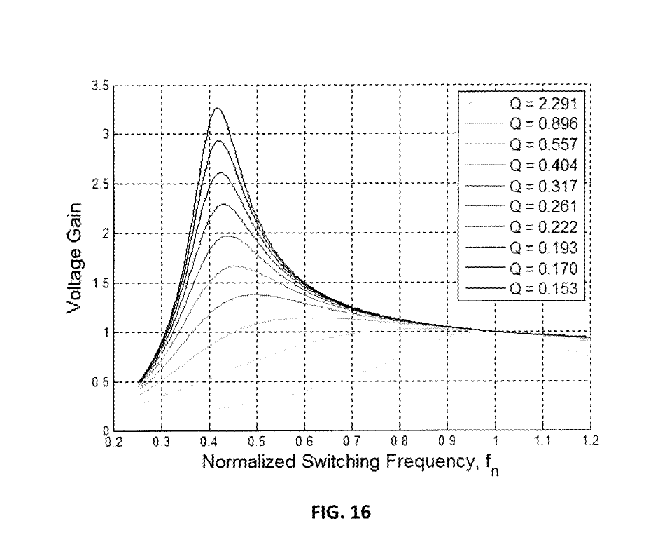

The voltage gain can be then calculated for different loadings and frequencies to produce the plots shown in FIG. 16. This figure shows the voltage gain achieved by an “LLC Resonant Tank”, as a function of normalized switching frequency of the input stage DC-AC converter.

The different lines are plots at different loading conditions (constant R), or stated alternatively, at different Q values as determined by Equation (4) below. As seen by the equation, as the load decreases (R decreases), the Q value is reduced in an inverse proportional relationship. In FIG. 16 the darker lines represent low Q values, and the lighter lines represent high Q values.

$$Q = \frac{\sqrt{\frac{{L}_{r} + {L}_{m}}{{C}_{r}}}}{\frac{8 R}{{π}^{2}}} \qquad ( 4 )$$

The resonant frequencies of the circuit are defined by fᵣ₁ and fᵣ₀, defined below

$$\begin{matrix}{f}_{0} = {f}_{r 1} = \frac{1}{2 π \sqrt{{L}_{r} {C}_{r}}} & ( 5 ) \\ {f}_{r 0} = \frac{1}{2 π \sqrt{( {L}_{r} + {L}_{m} ) {C}_{r}}} & ( 6 )\end{matrix}$$

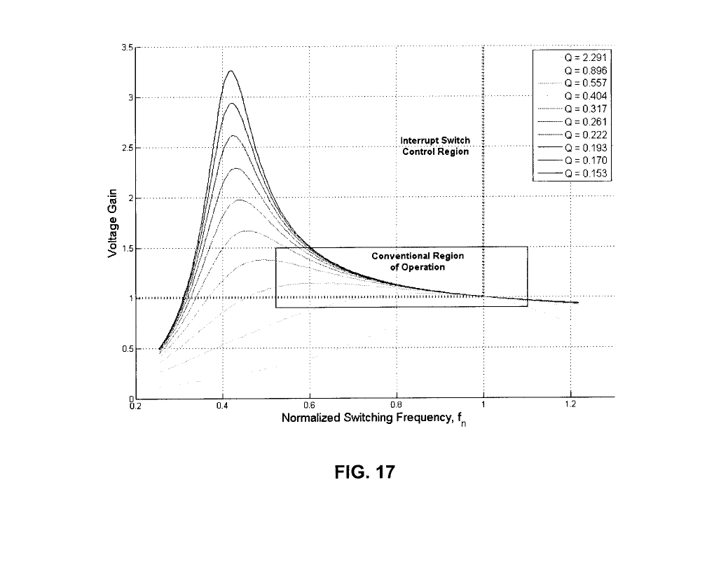

In conventional applications, such as power supplies, a Classic LLC Circuit is generally operated near fᵣ₁ as indicated in FIG. 17 by the box titled, “Conventional Region of Operation”, because a constant output voltage is desired throughout the entire load range. The desired ratio between the input voltage and output voltage is predominantly achieved using a transformer in the output stage, and not the LLC Resonant Tank itself. When the input voltage changes the output voltage is maintained at a constant level by adjusting the switching frequency of the input stage above or below fᵣ₁. The value of Q may not critical to the operation of the circuit and it may only be verified that the circuit can provide the required output voltage for the maximum load. Values of Q close or even higher than 1 are common in conventional circuits.

It has not been obvious to a person skilled in the art that the Classic LLC Circuit topology can be operated over a frequency range well below fᵣ₁ (fᵣ₁ is not within the operating range) by selecting the components such that the value of Q is well below 1 for the full load range specified. Furthermore, the circuit has not been used in applications that require control of the power transfer between two regulated or unregulated DC sources.

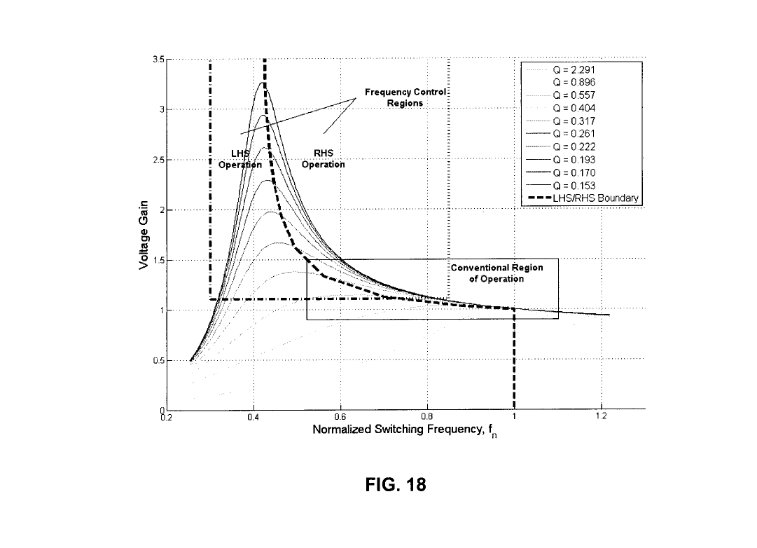

In one embodiment of the present invention, the LLC topology is designed to operate with switching frequencies well below fᵣ₁, close to the second resonant frequency of the circuit, fᵣ₀. Operation in the area near to can be divided into two distinct operating regions as shown in FIG. 18. As shown in the figure, the two regions are named the “LHS Operation” and “RHS Operation” regions. The line which intersects both of these regions is called the “LHS/RHS Boundary”, which is also shown in FIG. 18. Operation in the “LHS Operation” region yields zero current switching (ZCS), suitable for switching devices such as IGBT. Operation in the “RHS Operation” region yields zero voltage switching (ZVS), suitable for switching devices such as MOSFETs. Operating in any one of these regions yields a voltage gain above I for loads with Q lower than 1. The values of vie resonant tank components can be selected such that the Q value lower than 1 can be achieved for all load values (power transfers) required to be handled by Ute converter. This Q value would be lower for higher voltage boosting requirements. The system would then operate at a switching frequency below fᵣ₁ for all steady state operating conditions. A resonant tank circuit designed in accordance with this embodiment will be called a “High Voltage Boost Circuit” (HVBC). All of the embodiments of the invention shown above use a HVBC resonant tank circuit design. The introduction of a transformer to the circuit does not alter the high boost nature of the tank design.

For a specific application, the range of input voltage and the range of load (power transfer) is known. The output voltage is also known based on components to be powered by the converter or the externally regulated voltage bus that is to receive power. In one aspect of the invention what follows is a possible method for designing circuits based on said LLC topology, but providing relatively high boost ratios:

1) Choose an Lₘ/Lᵣ ratio that is suitable for the application. Typical values range from, but are not limited to, 3-10. Large values will result in higher peak currents in the tank, while small values will result in larger switching losses at low loads.
2) Generate voltage gain curves for various values of Q. On that plot, the boundary curve separating LHS and RHS regions may be graphed in a similar manner to that shown in FIG. 18.
3) From the plot, select the Q value whose voltage gain curve intersects with the boundary curve at the desired voltage boost ratio. Note the Q value and normalized frequency (fₙ) of this intersection point.
4) Using the Q and normalized frequency values found in step 3, calculate the Lᵣ and Cᵣ values.
5) Using the Lᵣ value calculated above and the desired Lₘ/Lᵣ ratio, calculate Iₘ

### Power Flow Control and Strategies or the LLC Boosting Converter

In a aspect, the first method discovered to achieve controllability of the above design was the introduction of an interrupt switch in the LLC Resonant Tank (the “Interrupt Switch LLC Circuit”). The interrupt switch allows the Q valve to be solely dependent on the input voltage and not the load. As the input voltage increases, the Q value decreases. The Input Stage switching frequency of the circuit is used to compensate for changes in the input voltage and the off time of the interrupt switch is used to adjust to the changes in load. The decoupling of the load (using the interrupt switch in the LLC Resonant Tank) from the input voltage (using the Input Stage switching frequency) allows for a simple implementation of a controller and stable control.

As disclosed in earlier described embodiments, the introduction of an interrupt switch into the LLC Resonant Tank also enables the use of the Interrupt Switch LLC Circuit in new applications where the LLC Resonant Tank is operated in the conventional region of operation close to fᵣ₁. The use of the Classic LLC Resonant Circuit in this operating region is not easily realizable with the classic frequency control method. In other words, the Interrupt Switch LLC Circuit is suited to new applications where the objective of the LLC circuit is not to regulate the output voltage but instead to regulate the power delivered to an output voltage regulated externally.

Those skilled in the at will understand that prior to the present invention, DC-DC converters of the type described in this disclosure would be operated in the “Conventional Region of Operation” shown in FIG. 18. However, when an LLC resonant tank Is operated in the conventional region of operation, depicted in FIG. 18, the various load curves begin to converge within this region. As the separation of the load curves becomes smaller, large load power transfer variations begin to occur, even for minute variations in the frequency. This makes power flow control impractical as the gain drops to near unity, since excessively fine frequency resolution is needed to achieve acceptable resolution in load power flow control. Even using a high performance frequency controller, load power control still becomes theoretically unachievable at unity gain. Thus is the reason why an interrupt switch is proposed in the Related Patents.

The inventors discovered that when operating the LLC resonant tank with a minimum boosting having an effective value above unity over the entire operating range, it was unnecessary to decouple the load from the input voltage using the interrupt switch referred to above.

The inventors discovered that if the LLC resonant tank is operated so as to be given sufficient boosting gain, a change in either the input voltage or the switching frequency results in a corresponding change in load (power transfer). This is illustrated in FIG. 19 for one possible circuit design that is adapted to deliver minimum boosting as described.

In particular, FIG. 19 illustrates maintenance of a fixed voltage gain of 2.0 while using frequency control to enable movement between the load curves. As shown in FIG. 18 for example in the “frequency control regions” there is horizontal separation amongst the load curves. Operation of the LLC Resonant Tank on a maintained basis in the frequency control regions suitably above unity gin enables better control of power transfer based on switching frequency, while maintaining the boosting ratio shown in FIG. 19.

This provides the reduced frequency range of operation required to control the load, and chopping of much smaller currents than conventional non-boosting LLC circuits.

A skilled reader will appreciate that components of a PC-DC converter designed to embody the mode of operation described may be selected so as to improve performance within the frequency range described.

Therefore, the objective of the design method of the present invention is to provide a DC-DC converter that is designed so that the boosting gain is above unity. Theoretically, the boosting gain can be designed as close to unity as desired provided a frequency controller with an infinite frequency resolution. Practical implementations of the converter which use frequency controllers with a finite resolution will require a minimum boosting gain above unity which achieves the desired controllability, i.e., the desired power flow resolution. For example, using currently available microcontroller hardware and a resonant frequency in the range of 50 kHz to 100 kHz, a boosting gain of 1.25 may be practical to maintain power flow controllability with practical power flow resolution over the entire operating range. A skilled reader will appreciate that this “minimum boosting gain above unity” will vary depending for example on the particular components selected, or that are available on an economic basis. Also, this will vary with further technical or manufacturing developments in regards to such components. Through use of an appropriate design methodology, as will be described later, it is possible to transfer any desired amount load power via frequency control by appropriate selection of circuit parameters.

### Detailed High Voltage Boost Circuit (HVBC) Operation

The operation of the HVBC will now be described more detail. As discussed, the HVBC is operated in a unique mode of operation. FIG. 18 shows the typical voltage gain that can be achieved with an LLC circuit, use different lines in FIG. 18 represent the same tank circuit with different loads. The lines then trace input the voltage gain from the converter when operated from about 0.4 times the resonant frequency fᵣ₁ to 1.2 times the resonant frequency fᵣ₁.

Conventionally, LLC power supplies are designed to operate near the resonant frequency defined by the resonant inductor and resonant capacitor, fᵣ₁. This region of operation can be seen in FIG. 17 with the resonant frequency fᵣ₁ denoted. When operated in this region near fᵣ₁ the circuit will exhibit constant voltage gin throughout the entire load range. FIG. 17 also shows the Interrupt Switch Control region, which covers parts of the conventional region of operation.

In the present HVBC embodiment, the LLC is designed such that it is operating very close to the resonant frequency determined by the resonant inductor, magnetizing inductor and the resonant capacitor, which will be referred to as Iᵣ₀. In FIG. 18, this operating region is outlined and labelled “LHS Operation” aid “RHS Operation”. In these regions of operation, the circuit is able to achieve high boost ratios yet also achieve a reduced switching loss throughout a wide load range. Output power is controlled by varying the switching frequency, which need only be varied by about 20% of the resonant frequency.

It will also be appreciated that the regions of operation as defined by FIGS. 17, 18 and 19 are for demonstration purposes only, and as such, they are not fixed to those values depicted in the figures. One of the defining characteristics of the present invention is that the resonant tank is designed and optimized such that it can provide a voltage boost when stimulated with an AC voltage whose frequency is less than fᵣ₁, or less than a normalized frequency of fₙ=1, as shown in FIGS. 17, 18 and 19. In FIG. 18, the borders of the “Conventional Region of Operation”, “RHS Operation” and “IS Operation” regions are not fixed, except for the border between the “RHS Operation” and “LHS Operation” region. This line is defined by the points where the resonant tank appears as a resistor to the AC stimulator, as described in the illustrative design example. The “Conventional Region of Operation” is focused around fᵣ₁, or a normalized frequency of fₙ= [symbol] in FIG. 18. The “LHS Operation” and “RHS Operation” regions are focused around fᵣ₀, or a normalized frequency of about fₙ=0.45 In FIG. 18. This normalized value will be different for every unique resonant tank design. In the same way the borders of FIG. 18 are not fixed, the regional borders of FIG. 17 are also not fixed, and are only drawn this way for demonstration purposes.

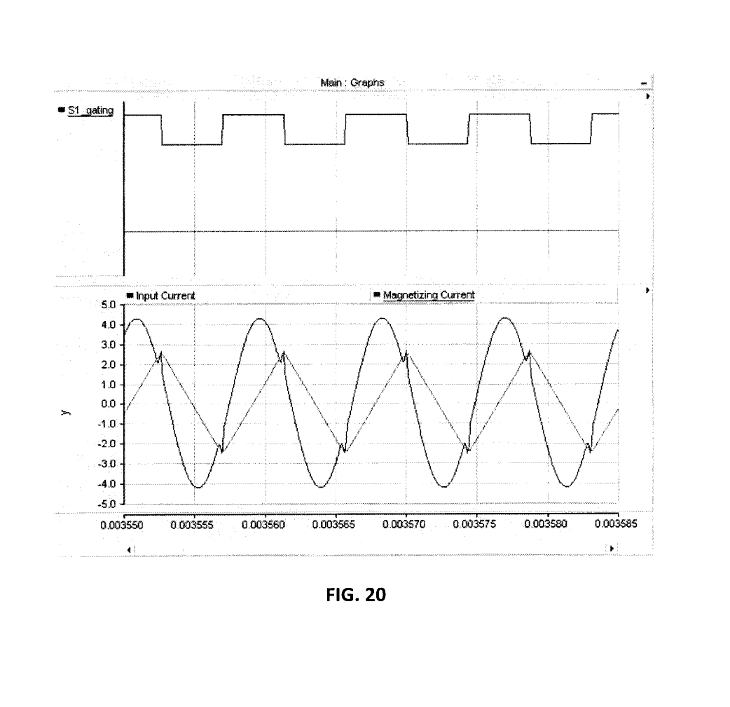

FIG. 20 shows the current waveform flowing out of the switching network in a conventional LLC circuit. Due to operation at fᵣ₁, the switching network mist switch a significant magnetizing current as compared to the peak current. FIG. 21 shows the waveforms associated with an embodiment of the circuit using an interrupt switch. The interrupt switch waits until negligible current is flowing in the switch, and opens the switch at near zero current. This effectively means the circuit is operating approximately on the ZCS/ZVS boundary shown in FIG. 18, at the boundary between the “LHS Operation” ad “RHS Operation” regions. Power is controlled by introducing a “hold” state as shown in FIG. 21. For full power operation, the hold state would be reduced to zero.

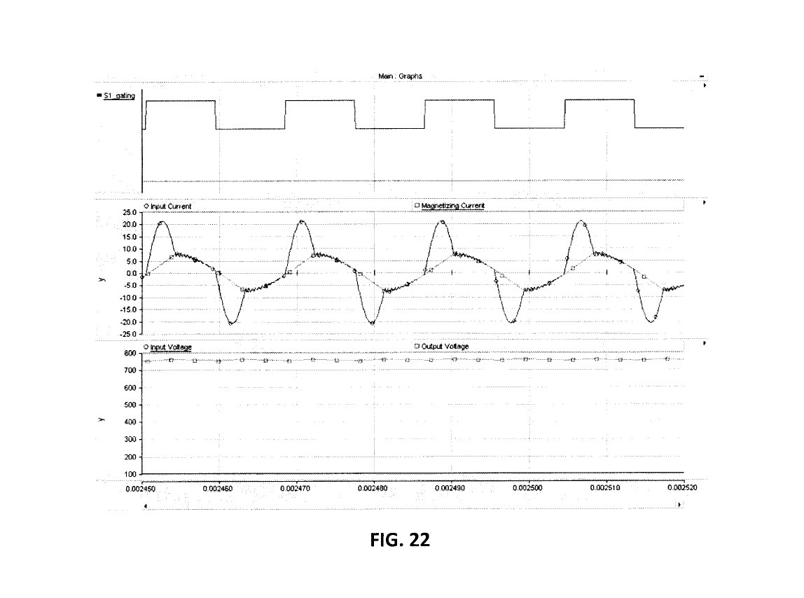

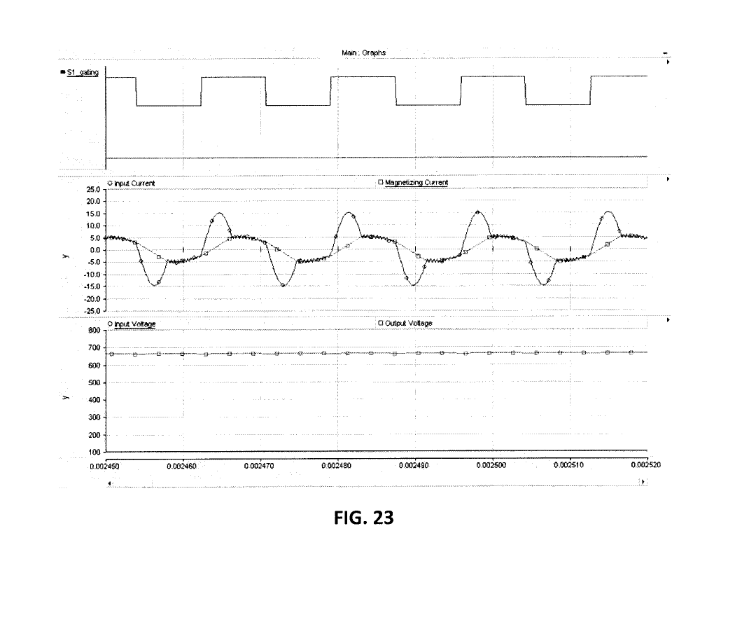

Now referring to FIG. 22, shown is a proposed mode of control over the presently described HVBC embodiment. At full power, the waveform will resemble the full power waveform of the circuit with the interrupt switch, with switching happening at or very near the zero crossing of the current. Power reduction, however, is achieved not by Introducing a hold state, but rather by slightly increasing the switching frequency of the converter as shown in FIG. 23. Switching action now occurs somewhat prior to the zero crossing; however the currents at the time of switching are very small, which can be seen in FIG. 23. Due to the low Q operation over the entire load range only small variations in the switching frequency are necessary to regulate power from full load to zero load. In FIGS. 22 and 23 for example, the switching frequency is increased from 55.5 kHz to 59.7 kHz and the power transfer Is reduced by about 25%.

The following is a description of a possible switching cycle method for an embodiment of the present invention utilizing a full-bridge DC-AC inverter and a split output circuit, operating in the “RHS Operation” region. The circuit is shown in FIG. 24(b) without transformer, 24(c) with transformer and 24(d) with transformer and one possible implementation with auto-balancing output voltage. The waveforms are shown in FIG. 22 for full load and FIG. 23 for partial load:
1. At the beginning of a cycle, a positive charge exists on the capacitor. The switching cycle begins with the turn of on of switches S₁ and S₂ₚ. The current in the resonant tank may be less than or equal to zero at this moment. Thereafter energy may be transferred into the resonant tank and because there Is enough voltage to forward bias the output rectifier diode, current is injected to the load.
2. The resonance will reduce the voltage in Cᵣ and will increase the current in the inductor Lr. Lm has a constant voltage equal to V [symbol] across it. The voltage across Cᵣ will turn negative and the current across Lr will start decreasing.
3. When the current across Lr equals the current across Lm, the output rectifier stops conducting and no current is transferred to the load. At this point, Lm is included in the resonance and the same current flows through Lr and Lm.
4. Switches S₁ and S₂ₚ are then turned off; almost immediately thereafter switches S₂ and S₁ₚ are turned on. This commences the second half cycle which is symmetrical to the first.
5. The length of the switching period may be varied to control the power flow through the converter.

Although the above control descriptions are based on the circuit using a full bridge DC-AC converter and the split output circuit, a person skilled in the art could be able to identify that the general operation, is similar in other embodiments. Differences in the number of pulses transferred per period, the type of load receiving the power pulses, or the location of the components used to produce the resonance amongst other do not change the operation principles for the circuit.

The benefits of the circuit over the classical LLC converter control are (a significantly longer switching period (approximately 2 times) for a given set of components; (ii) a reduction in switching losses; (ii) a reduction in losses within the resonant tank (comprised of Cᵣ, Lᵣ and Lₘ); and (iv) the ability to regulate power transfer between two externally determined DC sources.

### Unipolar/Bipolar Resonant Tank Excitation Control

As described earlier, switching of the DC/AC converter may be carried out such that the DC/AC converter output is either an AC waveform of +V1 and −V1, or an AC waveform of either V1 and 0 or −V1 and 0. The ability to switch between these modes of operation will be called “Unipolar/Bipolar Resonant Tank Excitation Control”. Unipolar/Bipolar Resonant Tank Excitation Control changes how the resonant tank is excited in order to operate the converter in its most efficient control mode for a given input power.

### Bi-Polar Output

As shown in FIG. 24(b) and FIG. 24(c), an embodiment of the invention includes a bipolar output voltage. This configuration is advantageous since the maximum voltage to neutral is reduced by a factor of two. As a consequence, cabling with a lower insolation class can be used, reducing the coat of wiring the converter. The use of two voltage sources to create the bi-polar output ensures that the output of the converter is always balanced to the neutral point.

### Auto Balancing Output

As shown in FIG. 6(c) and FIG. 7, an embodiment of the invention includes a voltage doubling rectifier, which creates a bi-polar output. This bi-polar output must be balanced in order to properly maintain the output DC link. Doe to the boosting name of the converter, the output capacitors, Co in FIG. 24(d), are automatically balanced. When one of the capacitors has a lower voltage than the other, the operating point of the converter moves vertically down the curves shown in FIG. 18. Moving down these curves corresponds to a higher Q value or larger load. A larger load means more power will be transferred, which will in turn charge the capacitor back to its nominal operating voltage. No other control circuitry is needed.

In summary, the focus of the present embodiment is on a unique mode of operation that yields a large voltage boost in the resonant tank. This voltage boost allows the present HVBC embodiment to achieve very high efficiencies at high conversion ratios. With the present HVBC design, the resonant tank of an LC converter can be designed to yield high voltage gain, useful for step up converters. As well, the converter can be operated with a low Q over the entire load range. This is achieved by knowing the load, and designing the resonant components around it. Furthermore, the resonant tank can be stimulated near the resonant frequency fᵣ₀, and operation of the converter in this region yields to ZVS, and low current switching (LCS), to yield a highly efficient, step up converter. This mode of operation makes is viable for the converter to transfer power between two externally determined voltage sources.

Comparative Analysis of Interrupt Switch Control Vs. Frequency Control for Boosting LLC Tank Circuits

As noted above, both interrupt switch control and frequency control may be used for boosting LLC Tank Circuits. This analysis focuses on the application of the interrupt switch concept to LLC converter applications and compares it to frequency control of the LLC converter.

Resonant converters are designed to transfer power from an input source to an output load. The output voltage divide by the input voltage is referred to as the gain of the converter. The theoretical pin of the LLC converter can be approximated using first harmonic approximation (FHA) techniques, it is then analyzed using the simplified approximate circuit shown in FIG. 15, where R [symbol] =8R/π² [See H. Huang. “LLC Resonant Half Bridge Converter”, Texas Instruments Presentation from Asia Tech-day, Aug. 27, 2009.] and R is the DC load resistance across a conventional full bridge output rectifier.

In many applications we wish to supply a constant output voltage, Vₒ, from a given input voltage source, approximated by V [symbol] . Based on the simplified model, the amount of current, Iₘ, flowing in Lm will be constant for a given Vₒ. In contrast the amount of current flowing in the load, I_{c}, will depend on the load resistance R [symbol] .

The current, Iᵣ, seen by the input ac source, the capacitor Cᵣ and the inductor Lᵣ therefore has two components:
(i) the component Iₘ, set by the desired Vₒ; and
(ii) the component I [symbol] , set by the loading.

The current Iₘ itself transfers no power to the load, it is merely required to enable the process of energy transfer.

At higher load I_{c} comprises a large percentage of Iᵣ, leading to highly efficient operation.

Using frequency control, lighter loading conditions result in Iₘ comprising a larger percentage of Iᵣ. Since numerous loses are related the amplitude of Iᵣ, efficiency will suffer at light load conditions. Particularly at power levels below 15% of rated power, the efficiency typically becomes very poor.

The interrupt switch enables a high Iₑ to Iᵣ ratio to be employed under all loading conditions. At full load the Iₑ to Iᵣ ratio is high by its very nature, posing no challenge. To operate at reduced load the interrupt switch introduces a near zero loss hold state. This yields an efficiency that is roughly independent of loading conditions. It should also be noted that each time the convert leaves the hold state one pulse of energy is transferred to the output. For a given input and output voltage the sine of this energy pulse Is constant. Power transfer is controlled by merely regulating the number of energy pulses that are released by the interrupt switch.

FIG. 22 shows a comparison of where the interrupt circuit operates versus where the frequency control circuit operates for a fixed V_{S} to Vₒ ratio of 1:2. Note that only one point is shown for the interrupt circuit operation. The interrupt switch pulses the power to the output always at one point on this plane. By controlling the pulse density the amount of power transfer is linearly controlled.

Under frequency control we operate along a horizontal line, moving to higher frequencies to decrease power. The amount of power transfer varies nonlinearly with the operating frequency.

A clear negative impact of employing the interrupt switch is that this device adds additional conduction losses to the resonant tank circuit.

This leads to a trade-off between low power and high power efficiency ma follows:
A converter that operates predominantly at a small percentage of is rated power will benefit from the interrupt switch, since efficiency is held high even at low power transfer through the interrupt process.
A converter that operates predominantly at a large percentage of its rated power will benefit from elimination of the interrupt switch, since efficiency of the converter is already high due to the large power transfer. Elimination of the interrupt switch conduction loss can be beneficial.

### Benefits of Interrupt Switch Control

The following is a list of benefits of the interrupt switch:
High efficiency at low power as noted above.
The power transfer between two fixed voltage source is proportional to the time Interval between interrupt switch turn-on events. This enables simple control of the circuit.
The power transfer between to the output is easily controllable even under lower boost ratios.
Use of the interrupt switch reduces switching losses in the input DC/AC converter that is supplied by V_{g} by ensuring soft-switching.

### Drawbacks of Interrupt Switch Control

The following is a list of drawbacks of the interrupt switch:
Addition of switch conduction loss to the tank circuit, reducing high power efficiency.
Component cost.

### Benefits of Frequency Control

The following are benefits of tow using frequency control in place of interrupt control in an LLC converter:
Efficiency at high power can be enhanced through elimination of conduction losses associated with Interrupt switch.
Reduction in component cost, due to elimination of interrupt switch.
Reduction in both input and output DC filter size.

### Drawbacks of Frequency Control

The following we drawbacks of the using frequency control in place of interrupt control in an LLC converter.
Low efficiency at light loads.
Highly nonlinear power transfer equation leading to more challenging controller design.
Control challenges in regulating power flow between two fixed voltage sources when the boost ratio is low.

### Application Examples of the Classic LLC Circuit Operating in the Novel Region of Operation

Using an operating range on the right hand side of the peak may be implemented with MOSFETs, because these switches have favorable performance when operated with zero voltage switching (“RHS Operation” as illustrated in FIG. 18).
Using an operating range on the left hand side of the peak may be implemented with IGBTs, because these switches have favorable performance when operated with zero current switching (“LHS Operation” as illustrated in FIG. 18).
RHS Operation for use in low voltage applications.
LS Operation for use in high voltage applications.
Such applications include, but are not limited to, solar photovoltaic systems, fuel cells, permanent magnet wind turbines, electric and hybrid vehicles, electric charging stations, aerospace applications, marine applications, micro-grids, energy storage and other systems that require converters with varying input voltage and load.

### Application Examples of the Interrupt Switch LLC Circuit Operating in the Novel Region of Operation:

The interrupt switch topology Is used in two main applications:

1. In applications where a high efficiency is desired and the converter operates at low power for long periods of times, such as standby power applications.
2. In low boosting applications where the power flow between two voltage sources needs to be controlled, including but not limited to, i) residential application of solar photovoltaic systems (including module level optimizers and micro-inverter), fuel cells, permanent magnet wind turbines, micro-grids and energy storage ii) small power marine and aerospace applications (low voltage); and iii) and other systems that require converters with varying input voltage and load at low input and output voltages.

### Illustrative Design Example

This design example illustrates how the selection of appropriate components in an LLC converter can yield the desired low Q operation. A brief overview of the theory will be presented followed by a step-by-step design example. The document concludes with a discussion section about the component selection.

The theoretical gain of the LLC converter can be approximated using first harmonic approximation (FHA) techniques. Assuming the circuit is stimulated by a perfect sinusoid, one can use conventional circuit analysis to determine the voltage gain of the circuit. The LLC converter under study can be simplified to the circuit shown in FIG. 15 where Re=8R/π² [H. Huang, above.] and R is the DC load resistance across a conventional full bridge output rectifier.

It can be shown that the voltage gain of the circuit is defined by:

$$M = \frac{{V}_{c}}{{V}_{g}} = \vert \frac{α {f}_{n}^{2}}{α {f}_{n}^{2} + ( {f}_{n}^{2} - 1 ) ( 1 + {if}_{n} α {Q}_{s} )} \vert \qquad ( 7 )$$

where

$$\begin{matrix}α = \frac{{L}_{m}}{{L}_{r}} & ( 8 ) \\ {f}_{n} = \frac{f}{{f}_{n}} & ( 9 ) \\ Q = \frac{\sqrt{{L}_{r} / {C}_{r}}}{{R}_{s}} & ( 10 ) \\ {f}_{0} = \frac{1}{2 π \sqrt{{L}_{r} {C}_{r}}} & ( 11 )\end{matrix}$$

Furthermore, one can find a transfer function between the input voltage and the resonant current, Iᵣ. The phase of the resonant current determines the region of operation of the converter. For example, if the resonant current is leading the input voltage, the LC converter is in the “LHS Operation” region. Conversely, when the resonant current is lagging the input voltage, the converter is in the “RHS Operation” region. The border between the two regions is where the resonant tank behaves like a perfect resistor. The dashed line in FIG. 18 shows this border.

The values that make up the dashed line can be determined by setting the imaginary part of the input voltage to resonant current transfer function to zero. The result is to solve for the roots or the following quadratic equation in ω² (ω*2πf);

$$\text{?} - {ω}^{2} ( {L}_{r} {C}_{r} \text{?} + {L}_{m} {C}_{r} \text{?} - {L}_{m}^{2} ) - \text{?} {L}_{r} {C}_{r} = 0 \\ \text{?} \text{indicates text missing or illegible when filed} \qquad ( 12 )$$

For voltage boosting applications, the circuit must be designed such that it can operate with voltage gains greater than 1. In FIG. 18, this is achieved by designing the converter around a low Q value. As shown, lower Q values provide a larger voltage boost at the output in addition to a low Q value, the converter will be operated at switching frequencies closer to the dashed line. These observations are in contrast to traditional LLC designs, where the converter is designed with larger Q values and operated near the resonant frequency, f₀. Designs that follow those traditional constraints exhibit unity voltage gain for all loads.

### Converter Design Procedure

This section will present an iterative design procedure to design the components for an LLC circuit based on a low Q operation.

Consider the following design constraints:
V_{in minimum}=50V
V_{in maximum}=90V
V_{out minimum}=180V
V_{out maximum}=200V
Pₘₐₓ=500 W
f_{switching minimum}=300 kHz±5 kHz

Therefore, we can determine:

R=Vₒᵤₜ²/Pₘₐₓ=80 Ω

R_{c}=8R/π²=64.8 Ω

Mₘₐₓᵢₘᵤₘ=V_{out maximum}/V_{in maximum}=200V/50V=4

Mₘᵢₙᵢₘᵤₘ=V_{out minimum}/V_{in minimum}=180V/90V=2

Using these design constraints, the Cᵣ, Lᵣ, and Lₘ need to be determined.

As calculated above, this particular example of a converter requires a maximum gain of 4 based on the voltage that converter will be exposed to. Therefore, the method enables the determination of the resonant components that will yield the required maximum voltage gain, while operating in the LHS region. A skilled reader will appreciate that maximum gain drives the circuit design.

### Design Steps

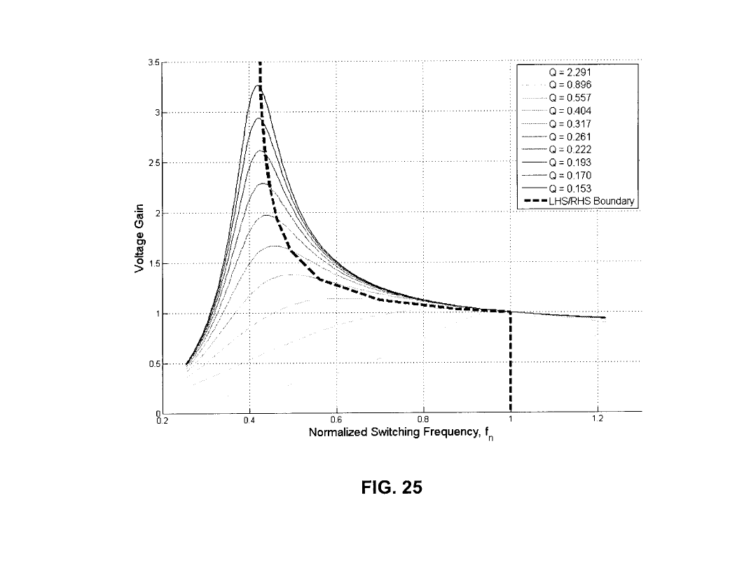

1) Ensure minimum gain is sufficient to offer high-resolution control of power with available control hardware. With existing hardware Mₘᵢₙᵢₘᵤₘ greater than 1.25 typically achieves this objective. If this minimum gain is too high for the application, introduce transformer with appropriate [symbol] ratio to ensure the required minimum gain.
2) Choose an Lₘ/Lᵣ ratio that iii suitable for the application. Typical values range from, but are not limited to, 3-10. Large values will result in higher peak currents in the tank, while small values will result in larger switching losses at low loads.
3) Generate voltage gain curves for various values of Q. On that plot, also graph the boundary curve separating LHS and RHS regions, similar to FIG. 25.
4) From the plot, select the Q value whose voltage gain curve intersects with boundary curve at the maximum voltage boost ratio, Mₘₐₓᵢₘᵤₘ. This ensures the required maximum power can be transferred even under maximum boosting conditions. Note the Q value and normalized frequency (fₙ) of this intersection point.
5) Using the Q and normalized frequency values found in step 4, calculate the Lᵣ and Cᵣ values using equations 9, 10 and 11.
6) Using the Lᵣ value calculated above and the desired Lₘ/Lᵣ, ratio, calculate Lₘ

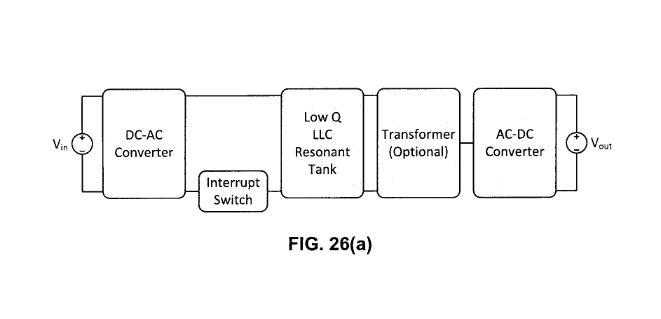

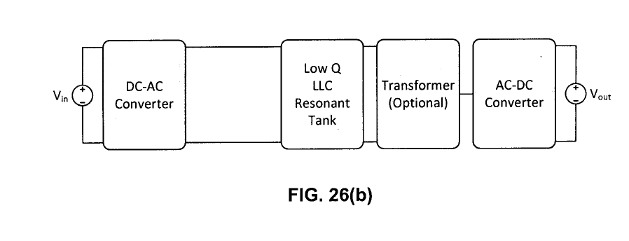

The design process can be easily automated through software and can be applied to any general form of the LLC circuit as shown in FIG. 26(a) with the interrupt switch and FIG. 26(b) without the interrupt switch.

### Converter Design

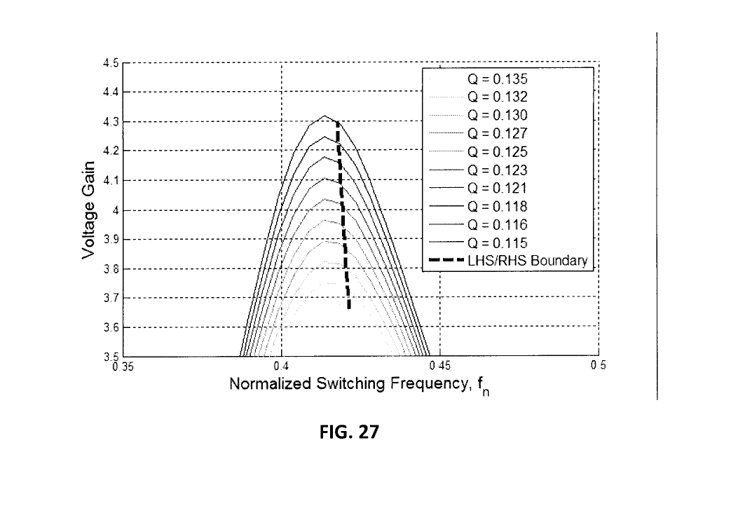

This section will implement the design step presented in the previous section to the converter constraints listed above.
1) Check if sufficient minimum gain conditions are met based on available control hardware. Here minimum gain is 2, which will allow high resolution power flow control using conventional control hardware.
2) Select an Lₘ/Lᵣ ratio of 5.
3) Zooming in on the voltage gain curves of FIG. 25 yields FIG. 27.
4) From the plot, choose a Q value of 0.123. This voltage gain curve intersects the resistive mode curve (the dashed line) at about 0.42×f₀.
5) Assigning f₀=f_{switching minimum} a and using equations 9, 10 and 11, the Lᵣ and Cᵣ values can be determined to be:
   Cᵣ=28 nF
   Lᵣ=0.8 μH
6) Using the Lᵣ value and the chosen Lₘ/Lᵣ ratio of 5, Lₘ=9 μH.

The final converter design can then have LLC components with the following values:
Cᵣ=28 nF
Lᵣ=0.8 μH
Lₘ=9 μH
Qₘₐₓ=0.123

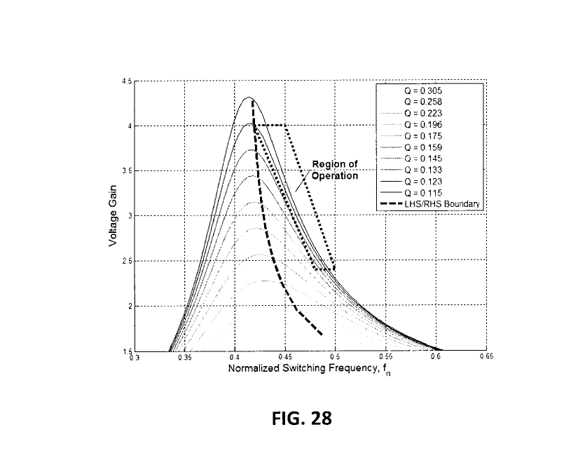

FIG. 28 shows the voltage gain curves of the designed converter, as well as the region of operation. Now how the region of operation remains in the “RHS Operation” region.

The converter design described in the previous sec don 12 unique for the given constraints and the selected Lₘ/Lᵣ ratio. However, each time the designer selects new constraints, a new sat of components must be calculated. As a consequence, there are in Infinite number of different LLC converters that operate with high boosting and low Q. Table A shows a small sample of possible resonant Link component values for converters designed to operate at 300 kHz and various Q and voltage boosting values. All of these converters may be successfully operated using frequency control to regulate load power.

TABLE A

| [symbol] | [symbol] | [symbol] | [symbol] | [symbol] | [symbol] | [symbol] |
|---|---|---|---|---|---|---|
| 8 | 302 | 80 | 52 | 1.1 | 4.3 | 0.07 |
| 2 | 298 | 40 | 28 | 2.5 | 10 | 0.29 |
| 4 | 296 | 80 | 27 | 2.25 | 9 | 0.14 |
| 4 | 302 | 40 | 53 | 1.1 | 4.4 | 0.14 |

[symbol]

indicates data missing or illegible when filed

This design methodology is used to design resonant LLC converters with high voltage gain. Traditionally, resonant LLC converters are designed with unity voltage gain, for voltage step down conversion. As a result, traditional designs will have larger Q values, and will operate near the resonant frequency fᵣ₁.

It will be appreciated by those skilled in the art that other variations of the embodiments described herein may also be practiced without departing from the scope of the invention. Other modifications are therefore possible. A skilled reader will recognize that the are numerous applications for the DC-DC converter technology described. The DC-DC converters of the present invention may provide an efficient, low cost alternative to numerous components providing high input-to-output voltage conversion. Moreover, DC-DC converters with high amplification ratios that are embodiments of the present invention may be used to create a fixed voltage DC bus in renewable/alternative energy applications.

A skilled reader will understand that the (A) method of operating a resonant DC-DC converter of the present invention; (B) the DC-DC converter disclosed herein; and (C) the method of designing a resonant DC-DC converter for high voltage boost ratio, may be used in connection with a range of different applications, including in connection with photovoltaic systems; a fuel cells; permanent magnet wind turbines; electric and hybrid vehicles; electric charge stations; aerospace systems; marine systems; power grids or smart grids including micro grids; and energy storage systems.

1. A method of operating a resonant DC-DC converter, the resonant DC-DC converter comprising a high voltage boost LLC circuit, characterized in that the method comprises:
(a) providing variable power flow control to the LLC circuit with externally determined input and output voltages using frequency control.

2. The method of claim 1, wherein the externally determined output voltage is created by either a single externally determined output voltage, or a series connection of two externally determined output voltages to crease a bi-polar output.

3. The method of claim 1, wherein frequency control is applied such that it emulates different loading conditions thus operating along horizontal curves on the voltage gain competed to the switching frequency operating plane.

4. The method of claim 1, wherein the LLC circuit include man LLC resonant tank, and wherein the LLC resonant tank operates with a minimum boosting having an effective value that is above unity over the entire operating range.

5. The method of claim 4, wherein the minimum boosting results in controllable transfer of power via change of switching frequency.

6. The method of claim 4, further comprising maintaining an externally determined voltage gain and using frequency control to enable movement between the load curves, and to control this movement within a frequency control region where there is horizontal separation amongst the load curves.

7. The method of claim 1, further comprising:
(a) operating the high voltage boost LLC circuit in a region close to a resonant frequency determined by a resonant inductor, magnetizing inductor and a resonant capacitor, to achieve a high voltage boost; and
(b) utilizing unipolar or bipolar resonant tank excitation to improve converter efficiency in the high voltage boost circuit.

8. The method of claim 2, further comprising a balanced bipolar DC output wherein the output capacitor voltages are automatically balanced.

9. The method of claim 2, wherein the DC-DC converter further includes a resonant inductor, a magnetizing inductor and a resonant capacitor, and the method comprises the further step of selecting these components such that the yield over the entire range of operation is an effective voltage gain that is greater than unity.

10. The method of claim 9, wherein the LLC converter is implemented with a transformer to allow decoupling of the resonant circuit gain from the externally determined voltage gain.

11. The method of claim 10, wherein the effective voltage gain value and the components are selected so as to minimise the effective voltage gain of the resonant circuit, while being greater than unity, and provide controllability of the DC-DC converter via frequency.

12. The method of claim 2, further comprising operating at a range of input stage switching frequencies in an LLC circuit whereby a change in input voltage result in a change in load or transferred power, such that a decoupling between the input voltage and load is not required.

13. A resonant DC-DC converter for high voltage step-up ratio, characterized in that the resonant DC-DC converter for high voltage step-up radio comprises:
(a) a low voltage full-ridge or half-bridge DC-AC converter
(b) an LLC resonant tank;
(c) a high voltage AC-DC converter or rectifier, and
(d) a high voltage controllable switch;
wherein the high voltage controllable switch is controllable to regulate power flow from an input to an output of the DC-DC converter based on an externally determined voltage gain ratio, wherein the LLC resonant tank operates with a minimum boosting having an affective value above unity over the entire operating range.

14. The DC-DC converter of claim 12, designed to provide variable power flow control using frequency control.

15. The DC-DC converter of claim 14, wherein application of frequency control emulates different loading condition thus enabling operation along horizontal curves on a voltage gain compared to a switching frequency operating plane.

16. The DC-DC converter of claim 14, wherein the minimum boosting results in controllable transfer of power based on change of switching frequency.

17. The DC-DC converter of claim 14, that maintains an externally determined voltage gain, and us frequency control to enable movement between the load curves, and controls this movement within a frequency control region where there is horizontal separation amongst the load curves.

18. The DC-DC converter of claim 14, designed for:
(a) operation of a high voltage boost LLC circuit in a region close to a resonant frequency determined by a resonant inductor, magnetizing inductor and a resonant capacitor, to achieve a high voltage boost; and
(b) use of unipolar or bipolar resonant tank excitation to improve converter efficiency in the high voltage boost circuit.

19. The DC-DC converter of claim 14, further comprising a balanced bipolar DC output wherein output capacitor voltages are automatically balanced.

20. The DC-DC converter of claim 14, wherein the DC-DC converter further includes a resonant inductor, a magnetizing inductor and a resonant capacitor, these components being selected such that the yield over the entire rang of operation is an effective voltage gain that is greater than unity.

21. The DC-DC converter of claim 14, comprising a transformer to allow decoupling of the resonant circuit gain from the externally determined voltage gain.

22. The DC-DC converter of claim 20, wherein the components are selected so as to minimize the effective voltage gain of the resonant circuit, while being greater than unity, and provide controllability of the DC-DC converter via frequency.

23. A method of designing a resonant DC-DC converter for high voltage boost ratio, the DC-DC converter comprising:
(a) a low voltage full-bridge or half-bridge DC-AC converter,
(b) an LLC resonant tank;
(c) a high voltage AC-DC converter or rectifier; and
(d) optionally, a high voltage controllable switch;
wherein the high voltage controllable switch is controllable to regulate power flow from an input to an output of the DC-DC converter based on a externally determined input to output voltage gain ratio maintained by the high voltage controllable switch using frequency control, wherein the DC-DC converter includes (i) a resonant capacitor, (ii) a resonant inductor, and (iii) a magnetizing inductor;
characterized in that the design method comprises:
(a) determining a minimum gin sufficient to enable high-resolution control of frequency using available control hardware;
(b) selecting an Lₘ/Lᵣ ratio that is suitable for an application for the DC-DC converter;
(c) generating voltage gain curves for various values of Q, and plotting these values so as to graph a boundary curve that defines LHS and RHS regions, and selecting the Q values whose voltage gain curve intersects with boundary curve at the maximum voltage boost ratio, thereby defining a set of normalized frequency values; and
(d) using the Q values and the normalized frequency values found to calculate values for the resonant capacitor, the resonant inductor, and the magnetizing Inductor so as to enable selection of suitable components for the application.

24. The method of claim 1, wherein the output voltage is externally regulated.

25. The method of claim 24, further comprising externally regulating an output voltage and adjusting either current transfer or power transfer for the externally regulated output voltage using a converter.

26. The method of claim 1, comprising applying the method in connection with operation of:
(a) a photovoltaic system;
(b) a fuel cell;
(c) a permanent magnet wind turbine;
(d) electric and hybrid vehicles;
(e) electric charge stations;
(f) aerospace systems;
(g) marine systems;
(h) power grids or smart grids, including micro grids; or
(i) energy storage systems.
